(19) United States
(12) Patent Application Publication
(10) Pub. No.: US 2013/0073812 A1
(43) Pub. Date: Mar. 21, 2013

(54) CACHE MEMORY DEVICE, PROCESSOR, AND INFORMATION PROCESSING APPARATUS

(71) Applicants: Tatsunori Kanai, Kanagawa (JP); Tetsuro Kimura, Tokyo (JP); Koichi Fujisaki, Kanagawa (JP); Haruhiko Toyama, Kanagawa (JP)

(72) Inventors: Tatsunori Kanai, Kanagawa (JP); Tetsuro Kimura, Tokyo (JP); Koichi Fujisaki, Kanagawa (JP); Haruhiko Toyama, Kanagawa (JP)

(73) Assignee: KABUSHIKI KAISHA TOSHIBA, Tokyo (JP)

(21) Appl. No.: 13/546,274

(22) Filed: Jul. 11, 2012

(30) Foreign Application Priority Data
Sep. 16, 2011 (JP) 2011-202740

(51) Int. Cl. G06F 12/08

(52) U.S. Cl. 711/141; 711/E12.026

(57) ABSTRACT

According to an embodiment, a cache memory device caches data stored in or data to be stored in a memory device. The cache memory device includes a memory area that includes a plurality of cache lines; and a controller. When the number of dirty lines among the cache lines exceeds a predetermined number, the controller writes data of the dirty lines into the memory device, each of the dirty lines containing data that is not written in the memory device.

### CROSS-REFERENCE TO RELATED APPLICATION(S)

This application is based upon and claims the benefit of priority from Japanese Patent Application No. 2011-202740, filed on Sep. 16, 2011; the entire contents of which are incorporated herein by reference.

### FIELD

Embodiments described herein relates generally to a cache memory device, a processor, and an information processing apparatus.

### BACKGROUND

In information processing apparatuses, a processor executes a program by repeating inputting data from the outside, processing the input data, and outputting the result of the processing to the outside. When there is no process to be performed such as when the processor waits for the input of data from the outside or waits for the elapse of time set by a timer, the processor enters a standby mode with low power consumption. When the processor that is in the standby mode is notified of an input of data from the outside, an elapse of time set by the timer, or the like through an interrupt, the processor enters a mode (hereinafter, referred to as an “execution mode”) again in which a program is executed and starts an interrupt process.

The processor that is in the standby mode reduces power consumption by means of lowering the frequency of a clock, stopping the supply of a clock signal, stopping the supply of electric power, or the like for various modules (an arithmetic unit, cache memory, and the like) arranged inside the processor. At this time, the more the number of modules to which the supply of a clock signal or electric power is stopped is, the more the amount of reduction in power consumption is. Especially, in a modern processor that is highly integrated, the power consumption of cache memory is high due to a leakage current and the like. Accordingly, by stopping the supply of electric power to the cache memory in the standby mode, significant reduction in power consumption can be expected.

Cache memory is roughly classified into a write through type and a write back type based on a difference in the data writing method used by the processor. In a processor including cache memory of the write through type, in writing data into main memory by the processor, writing data into the cache memory and writing data into the main memory are simultaneously performed. In contrast to this, in a processor including cache memory of the write back type, writing data into the main memory by the processor is completed only by writing data into the cache memory, and the data is written into the main memory at later timing that is appropriate.

In the processor that includes cache memory of the write back type, when the writing of data into the cache memory is completed, the execution of a program can be continued without waiting for the completion of writing the data into the main memory. In addition, in a case where the processor writes data of the same address or data of the same line of the cache memory multiple times, such data can be collectively written into the main memory. Accordingly, generally, the process efficiency of the cache memory of the write back type is higher than that of the cache memory of the write through type, which also leads to reduction in the power consumption.

However, in the processor including cache memory of the write back type, when the supply of electric power to the cache memory is stopped, it is necessary to stop the supply of electric power to the cache memory after data, which has been written only into the cache memory but has not been written into the main memory, is written into the main memory. Accordingly, the cost (the time and the power consumption) required for switching from the execution mode to the standby mode in cache memory of the write back type is higher than that in cache memory of the write through type. While the cost required for entering the standby mode is negligible in a case where the frequency of switching to the standby mode, in which the supply of electric power to the cache memory is stopped, is low, the cost is not negligible in a case where the frequency is high. For example, in a case where the processor is configured to enter the standby mode, in which the supply of electric power to the cache memory is stopped, even for a very short standby time in units of several milliseconds to several tens of milliseconds so as to realize significant reduction in power consumption, the switching from the execution mode to the standby mode frequently occurs so as to increase the cost required for the switching, and accordingly, the reduction in power consumption is less than expected.

According to a conventional technique, the amount of reduction in the power consumption is not sufficient.

### BRIEF DESCRIPTION OF THE DRAWINGS

FIG. 1 is a diagram illustrating the exterior appearance of an information processing apparatus according to an embodiment;

FIG. 2 is a diagram illustrating the hardware configuration of an information processing apparatus according to an embodiment;

FIG. 3 is a diagram illustrating the overview of a cache memory device according to an embodiment;

FIG. 4 is a diagram illustrating the configuration of a cache memory device according to a first example;

FIG. 5 is a flowchart of the process performed by a reading control unit according to the first example;

FIG. 6 is a flowchart of the process performed by a writing control unit according to the first example;

FIG. 7 is a diagram illustrating the configuration of a cache memory device according to a second example;

FIG. 8 is a flowchart of the process performed by a reading control unit according to the second example;

FIG. 9 is a flowchart of the process performed by a writing control unit according to the second example;

FIG. 10 is a diagram illustrating the configuration of a cache memory device according to a third example;

FIG. 11 is a flowchart of the process performed by a reading control unit according to the third example;

FIG. 12 is a flowchart of the process performed by a writing control unit according to the third example;

FIG. 13 is a flowchart of the operation of a write buffer according to the third example;

FIG. 14 is a diagram illustrating the configuration of a cache memory device according to a fourth example;

FIG. 15 is a flowchart of the process performed by a writing control unit according to the fourth example;

FIG. 16 is a flowchart of the process performed by a writing back control unit according to the fourth example;

FIG. 17 is a flowchart of the process performed by the writing back control unit according to the fourth example;

FIG. 18 is a diagram illustrating the configuration of a cache memory device according to a fifth example;

FIG. 19 is a flowchart of the process performed by a writing control unit according to the fifth example;

FIG. 20 is a flowchart of the process performed by a writing back control unit according to the fifth example;

FIG. 21 is a flowchart of the process performed by the writing back control unit according to the fifth example;

FIG. 22 is a diagram illustrating the overview of a cache memory device according to a sixth example;

FIG. 23 is a diagram illustrating the configuration of a cache memory device according to the sixth example;

FIG. 24 is a flowchart of the process performed by a first reading control unit according to the sixth example;

FIG. 25 is a flowchart of the process performed by a first writing control unit according to the sixth example;

FIG. 26 is a flowchart of the process performed by the first writing control unit according to the sixth example;

FIG. 27 is a flowchart of the process performed by a second reading control unit according to the sixth example;

FIG. 28 is a flowchart of the process performed by a second writing control unit according to the sixth example; and

FIGS. 29A to 29C are diagrams illustrating variations in a processor according to an embodiment.

### DETAILED DESCRIPTION

According to an embodiment, a cache memory device caches data stored in or data to be stored in a memory device. The cache memory device includes a memory area that includes a plurality of cache lines; and a controller. When the number of dirty lines among the cache lines exceeds a predetermined number, the controller writes data of the dirty lines into the memory device, each of the dirty lines containing data that is not written in the memory device.

Hereinafter, a cache memory device, a processor, and an information processing apparatus according to embodiments will be described with reference to the drawings.

Information Processing Apparatus

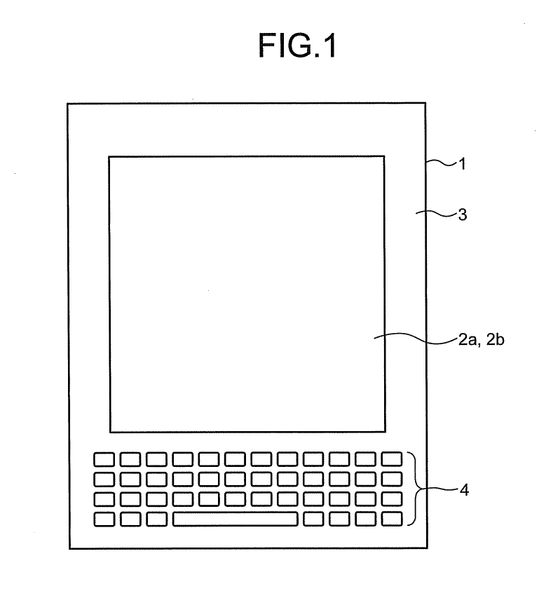

FIG. 1 is a diagram illustrating the exterior appearance of an information processing apparatus 1 according to this embodiment. This information processing apparatus 1 is configured as a tablet-type information terminal. The information processing apparatus 1 includes a display unit 2a on the terminal surface. As the display unit 2a, for example, a reflection-type liquid crystal display having low power consumption, an electronic paper unit, or the like is used. In addition, the information processing apparatus 1 includes a solar cell 3 in a portion other than the display unit 2a of the terminal surface. Furthermore, the information processing apparatus 1 includes a touch panel 2b that serves as a pointing device on the surface of the display unit 2a. In addition, the information processing apparatus 1 includes a keyboard 4 at a position not overlapping the display unit 2a disposed on the terminal surface. The keyboard 4 may be implemented by allowing a transparent touch panel 2b to overlap the surface of the solar cell 3. In addition, the keyboard 4 may be implemented as a mechanical keyboard 4 using a transparent material or a material that has a small portion having a light shielding property.

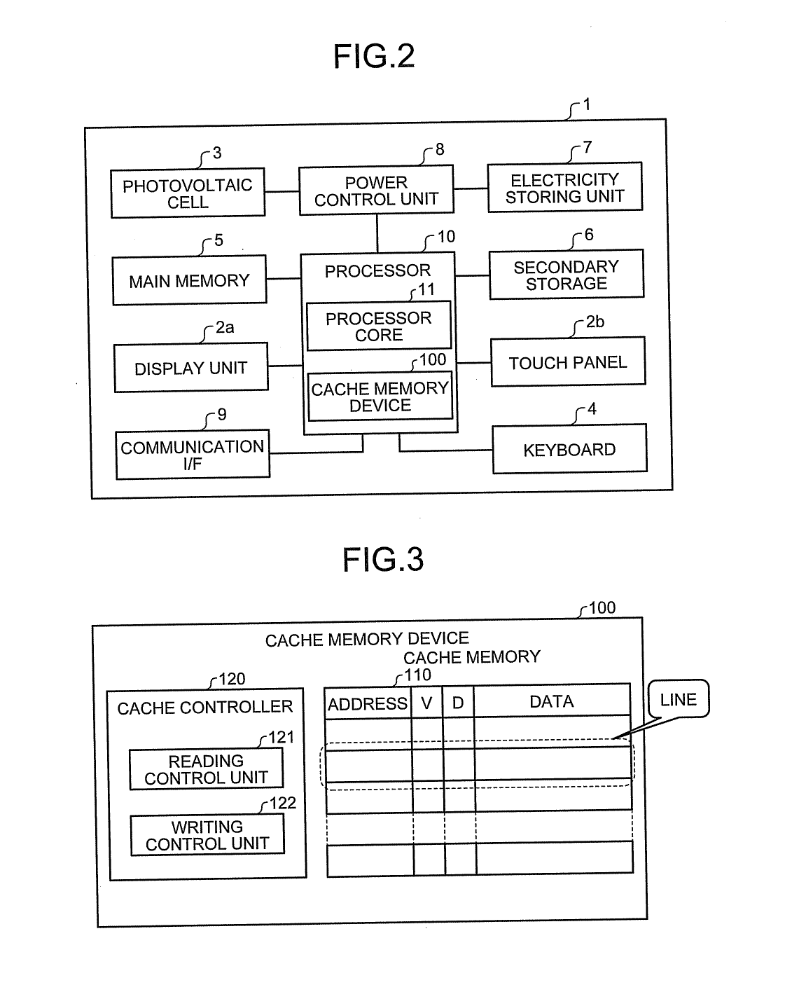

FIG. 2 is a block diagram illustrating an example of the hardware configuration of the information processing apparatus 1 according to this embodiment. The information processing apparatus 1 includes, as its main hardware configuration, a processor 10, main memory (memory device) 5, a secondary storage 6, the solar cell 3, an electricity storing unit 7, a power control unit 8, the display unit 2a, the touch panel 2b, the keyboard 4, and a communication interface (communication I/F) 9.

The information processing apparatus 1 operates with electric power that is generated by the solar cell 3. However, the peak power consumed by the whole information processing apparatus 1 at the time of an operation (at a time when an operation is executed) cannot be covered only by the electric power that is generated by the solar cell 3. Accordingly, surplus electric power that is generated by the solar cell 3 at an idle time (a time at which a response from a user is waited for, a time at which the information processing apparatus 1 is not used, or the like) is stored in the electricity storing unit 7. Then, at the time of an operation, the power control unit 8 performs a control operation such that the power stored in the electricity storing unit 7 is supplied to each unit of the information processing apparatus 1. Such a power control operation is also called a peak shift.

The electricity storing unit 7 can be implemented by using one of a battery such as a lithium ion battery, an electric double layer capacitor, and the like or a combination thereof. For example, a combination can be formed such that, first, the electric power generated by the solar cell 3 is stored in an electric double layer capacitor, and the stored electric power is further charged in a lithium ion battery.

The power control unit 8 manages the amount of electric power stored in the electricity storing unit 7 and has a function of notifying external configuration units such as the processor 10 and the like of the amount of electric power stored in the electricity storing unit 7. The function of notifying the processor 10 of the amount of electric power stored in the electricity storing unit 7, for example, can be implemented by configuring the power control unit 8 so as to notify the processor 10 of a time point at which the amount of electric power stored in the electricity storing unit 7 becomes less than a predetermined specified amount or a time point at which the amount of the stored electric power is more than the specified amount through an interrupt. In addition, as another implementation method, the power control unit 8 can be implemented so as to send back the current amount of electric power to the processor 10 in a case where a instruction is received from the processor 10.

The processor 10 controls the overall operation of the information processing apparatus 1 by executing an application program or an operating system. The information processing apparatus 1 according to this embodiment, for example, has an operating system such as Linux (registered trademark) mounted thereon.

The processor 10 includes a processor core 11 and a cache memory device 100. The processor core 11 executes an application program or an operating system while accessing the main memory 5. The cache memory device 100 caches a part of data stored in the main memory 5. By including the cache memory device 100 to be described later in detail, the processor 10 aggressively enters a deep standby mode in which the supply of electric power to the cache memory device 100 is stopped and realizes significant reduction in the power consumption in the standby mode.

The main memory 5 is realized by using non-volatile memory such as a magnetoresistive random access memory (MRAM) with a high read/write speed. Other than the MRAM, a phase change memory (PCM, it is also called PRAM or PCRAM) or a resistance random access memory (ReRAM) can be used as the main memory 5. In addition, low-power dynamic random access memory (DRAM) that has low power consumption at the time of standby or general DRAM may be used as the main memory 5.

The secondary storage 6 is an auxiliary memory unit that stores therein data and programs that are necessary for the information processing apparatus 1. For example, the secondary storage 6 can be realized by using a memory unit in which a flash memory chip is mounted. In addition, an SD card or an SSD can be used as the secondary storage 6.

The communication I/F 9 is an interface for communication, for example, through a wireless local area network (LAN) or the like. The communication protocol is not limited to the wireless LAN, but all the protocols such as a wired LAN, Bluetooth (registered trademark), ZigBee (registered trademark), infrared communication, visible light communication, an optical line network, a telephone line network, and the Internet can be used.

Overview of Cache Memory Device

Next, the cache memory device 100 that is included in the processor 10 of the information processing apparatus 1 according to this embodiment will be described. FIG. 3 is a diagram illustrating the overview of the cache memory device 100.

The cache memory device 100, as illustrated in FIG. 3, includes cache memory (memory area) 110 and a cache controller (controller) 120.

The cache memory 110 is memory area that stores therein cached data. The cache memory 110 includes a plurality of cache lines (hereinafter, simply referred to as “lines”). Each one of the lines of the cache memory 110 is configured to store therein a chunk of data in a fixed size. The size of data stored in each line is called a line size, and a representative example of the line size is 64 bytes. There is also a case in which each line of the cache memory 110 is referred to as an entry.

Each line of the cache memory 110 includes: an “address” field that designates the address on the main memory 5 of data in the line, a “valid flag (V)” that indicates that effective data is stored in the line, a “dirty flag (D)” that indicates that the line is a dirty line, and a “data” field that stores data of the line size and maintains a set of the four information pieces. The dirty line represents a line that is in a state in which write data of the processor 10 is stored therein, but the write data has not been written into the main memory 5. In addition, in examples to be described later, a method is described in which, the dirty flag (D) is set to OFF when the valid flag (V) of the line is set to OFF, and accordingly, it can be determined in a simple manner whether or not a line is a dirty line by checking the dirty flag (D). Alternatively, in a case where ON or OFF of the dirty flag (D) is not determined when the valid flag (V) of the line is set to OFF, by checking whether both the valid flag (V) and the dirty flag (D) are set to ON, it can be determined whether or not a line is a dirty line.

The cache controller 120 includes a reading control unit 121 and a writing control unit 122. The reading control unit 121 processes a data read request from the processor core 11 to read out data from the main memory 5. The writing control unit 122 processes a data write request from the processor core 11 to write data into the main memory 5. The size of data that is read from or written into the main memory 5 by the processor core 11 in accordance with one instruction accompanied with the execution of a program is smaller than the line size of the cache memory 110 such as 4 bytes, 1 byte, or 8 bytes.

In a case where the processor core 11 reads out data from the main memory 5, the reading control unit 121 of the cache controller 120, first, checks whether or not a line corresponding to a designated address is present in the cache memory 110 in accordance with a data read request from the processor core 11. Then, in a case where the corresponding line is present in the cache memory 110 (hit), the reading control unit 121 reads out data stored at the designated address from the cache memory 110 and sends back the data to the processor core 11. On the other hand, in a case where the corresponding line is not present in the cache memory 110 (miss-hit), the reading control unit 121 reads out data corresponding to the line size that includes data stored at the designated address from the main memory 5 and stores the read data in the cache memory 110, and then reads out the data stored at the designated address from the cache memory 110 and sends the read data back to the processor core 11. By collectively reading data corresponding to the line size from the main memory and writing the data into the cache memory 110 at the time of a miss-hit, when data stored at an address located in the vicinity thereof is accessed (read out or written) next, the data has already been written into the cache memory 110, and accordingly, the data can be accessed at high speed.

In a case where the processor core 11 writes data into the main memory 5, the writing control unit 122 of the cache controller 120, first, checks whether or not a line corresponding to a designated address is present in the cache memory 110 in accordance with a data write request from the processor core 11. Here, since in many cases the writing of data is to overwrite data that has been read out immediately previously or to write data into a neighboring address (high locality of reference), in many cases, a line corresponding to the address at which data is desired to be written is present in the cache memory 110. In a case where the corresponding line is present in the cache memory 110 (hit), the writing control unit 122 writes the data at the designated address. On the other hand, in a case where the corresponding line is not present in the cache memory 110 (miss-hit), the writing control unit 122, for example, reads out data corresponding to the line size that includes data stored at the designated address from the main memory 5 and stores the read data in the cache memory 110, and then rewrites the data stored at the designated address. Alternatively, there is also a method in which, at the time of a miss-hit, by securing a line of the cache memory 110 for data writing, writing data into several bytes in the line, and additionally preparing a flag representing the bytes into which the data is written, the data can be written into the cache memory 110 without accessing the main memory 5. Still alternatively, there is a method in which, at the time of a miss-hit, data is directly written into the main memory 5 without writing the data into the cache memory 110. This embodiment can be performed by combining any one of the processing methods at the time of a miss-hit.

Generally, as configurations of the cache memory device, a full associative type, a direct mapping type, an (n way) set associative type, and the like are known.

In a cache memory device of the full associative type, an address used by the processor core 11 for accessing the main memory 5 is divided into an upper part and a lower part, the “address” field of the cache memory 110 is searched with the upper address, and, in a case where there is a line having the “address” field in which the same address as the upper address is included, data located at a position designated by the lower address included in the “data” field of the line is accessed.

In the case of the direct mapping type or the set associative type, an address used by the processor core 11 for accessing the main memory 5 is divided into an upper part, a middle part, and a lower part, lines (in the case of the set associate type, a set of lines of each way) of the cache memory 110 are selected in accordance with the middle address, and, in a case where there is a line having the “address” field in which the same address as the upper address is included out of the selected lines, data located at a position designated by the lower address included in the “data” field of the line is accessed.

The cache memory device 100 according to this embodiment can employ any one of the above-described configurations that are generally known.

In addition, the cache memory device 100 according to this embodiment basically employs a data writing method of the write back type. In other words, the cache memory device 100 according to this embodiment writes (writes back) data of a dirty line of the cache memory 110 in which the dirty flag is set to ON into the main memory 5 at an appropriate time point that is later than the time when the data is written into the dirty line. There are various timings when the data of the dirty lines is written into the main memory 5, which include a timing when the data of the dirty lines is replaced so as to store the data stored at a different address that has been accessed by the processor core 11 (in other words, a timing when the dirty line is reused), a timing when the processor core 11 issues a instruction directing to purge (also called flash) the cache memory 110, a timing when an access is made from cache memory of another processor core of a multi-core processor, and the like.

The cache memory device 100 according to this embodiment manages the number of dirty lines, which are present within the cache memory 110, so as not to exceed a predetermined number (hereinafter, referred to as the “allowable number of lines”) that is set in advance. In other words, the cache memory device 100 according to this embodiment allows the cache controller 120 to have a function of writing (writing back) data of data lines into the main memory 5 in a case where the number of the dirty lines within the cache memory 110 exceeds the allowable number of lines. By having such a function to be included in the cache controller 120, the cache memory device 100 according to this embodiment decreases the frequency of writing data into the main memory 5 by utilizing the features of the write back type and can suppress the amount of data that is written back from the cache memory 110 to the main memory 5 in accordance with a instruction directing a purge, which is issued from the processor core 11, in a case where the supply of electric power to the cache memory device 100 is blocked while effectively suppressing the occurrence of a stall (a state in which the processor core 11 does not advance for executing a next instruction while waiting for the completion of writing data into the main memory 5) of the processor core 11 due to the waiting for the completion of writing data into the main memory 5. Accordingly, since the processor 10 including the cache memory device 100 according to this embodiment can reduce the time and the power consumption required for switching from the execution mode to the deep standby mode in which the supply of electric power to the cache memory device 100 is blocked, the switching to the deep standby mode can be performed even for a very short standby time, and power consumption can be significantly reduced.

In addition, a case will be described to which this embodiment is applied. In a processor including a cache memory of the write back type, when the supply of electric power to the cache memory is stopped, it is necessary to block the supply of electric power to the cache memory after data, which has been written only into the cache memory but has not been written into the main memory, is written into the main memory. Accordingly, the cost (the time and the power consumption) required for switching from the execution mode to the standby mode in cache memory of the write back type is higher than that in cache memory of the write through type. While the cost required for entering the standby mode is negligible in a case where the frequency of switching to the standby mode, in which the supply of electric power to the cache memory is stopped, is low, the cost is not negligible in a case where the frequency is high. For example, in a case where the processor is configured to enter the standby mode, in which the supply of electric power to the cache memory is stopped, even for a very short standby time in units of several milliseconds to several tens of milliseconds so as to realize significant reduction in power consumption, the switching from the execution mode to the standby mode frequently occurs so as to increase the cost required for the switching, and accordingly, the reduction in power consumption is less than expected. By applying this embodiment of the present invention to such a case, the frequency of writing data into the main memory during the execution of a program decreases, and the time and the power consumption required for switching from the execution mode to the standby mode can be suppressed.

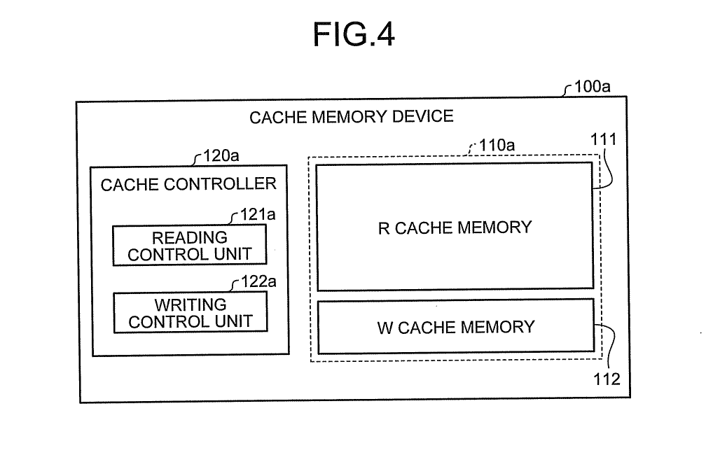

Hereinafter, specific examples (a first example to a sixth example) of the cache memory device 100 according to this embodiment will be described with reference to FIGS. 4 to 28. Hereinafter, a cache memory device of the first example will be denoted by a cache memory device 100a, a cache memory device of the second example will be denoted by a cache memory device 100b, a cache memory device of the third example will be denoted by a cache memory device 100c, a cache memory device of the fourth example will be denoted by a cache memory device 100d, a cache memory device of the fifth example will be denoted by a cache memory device 100e, and a cache memory device of the sixth example will be denoted by a cache memory device 100f.

### First Example

First, the cache memory device 100a of the first example will be described. FIG. 4 is a diagram illustrating the configuration of the cache memory device 100a according to the first example. The cache memory device 100a according to the first example includes a cache memory 110a and a cache controller 120a.

The cache memory 110a includes two memory units including R cache memory (first memory area) 111 and W cache memory (second memory area) 112. The R cache memory 111 is memory area that has lines, the number of which is arbitrary. The W cache memory 112 is memory area that has lines, the number of which is the allowable number of lines (the allowable number of dirty lines). While data read out by the processor 10 from the main memory 5 is stored in one of the R cache memory 111 and the W cache memory 112, data to be written into the main memory 5 by the processor 10 is stored only in the W cache memory 112. In other words, in the cache memory device 100a according to the first example, dirty lines are present only in the W cache memory 112. Accordingly, in each line of the R cache memory 111, a dirty flag (D) field is not necessary.

The cache controller 120a includes a reading control unit 121a and a writing control unit 122a.

When there is a data read request from the processor core 11 to read out data from the main memory 5, the reading control unit 121a performs data reading for both the R cache memory 111 and the W cache memory 112 as targets.

On the other hand, when there is a data write request from the processor core 11 to write data into the main memory 5, the writing control unit 122a performs data writing only for the W cache memory 112 as a target. Then, in a case where all the lines of the W cache memory 112 are dirty lines, and it is necessary to secure a line for writing new data, the writing control unit 122a releases a line by writing back the data of the dirty lines into the main memory 5 and then writes data into the line. Accordingly, the number of dirty lines that are present within the cache memory 110a can be configured to be constantly the allowable number of lines or less.

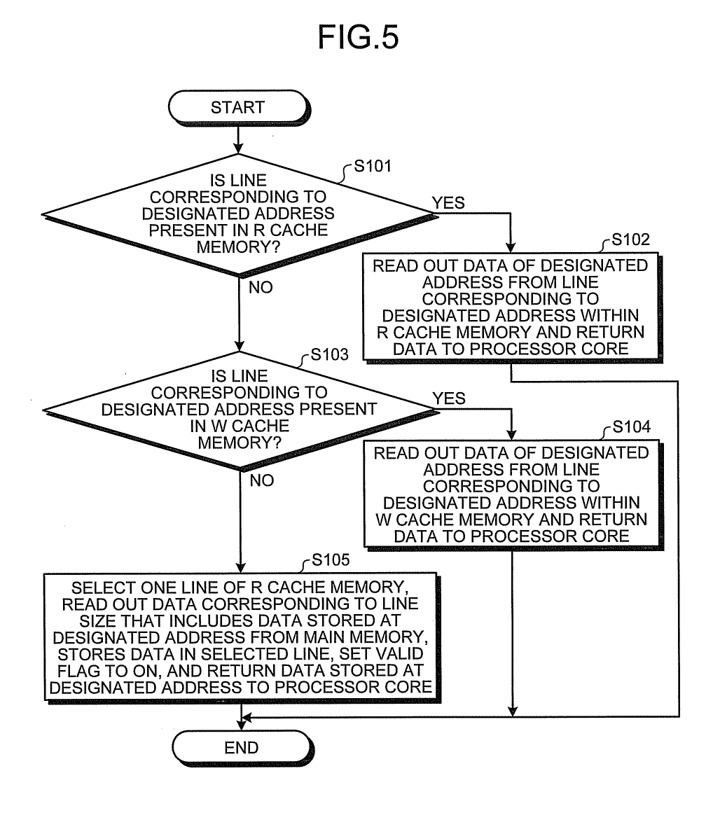

FIG. 5 is a flowchart illustrating the process performed by the reading control unit 121a of the cache controller 120a when the processor core 11 issues a data read request to read data from the main memory 5.

When the processor core 11 issues a data read request to read data from the main memory 5, the reading control unit 121a, first, determines whether or not a line corresponding to the designated address is present within the R cache memory 111 in Step S101. Then, in a case where the line corresponding to the designated address is present within the R cache memory 111 (Yes in Step S101), the reading control unit 121a reads out data stored at an address designated from the corresponding line and returns the data to the processor core 11 in Step S102.

On the other hand, in a case where the line corresponding to the designated address is not present within the R cache memory 111 (No in Step S101), the reading control unit 121a, next, determines whether or not the line corresponding to the designated address is present within the W cache memory 112 in Step S103. Then, in a case where the line corresponding to the designated address is present within the W cache memory 112 (Yes in Step S103), the reading control unit 121a reads out data stored at an address designated from the corresponding line and returns the data to the processor core 11 in Step S104.

On the other hand, in a case where the line corresponding to the designated address is not present within the W cache memory 112 (No in Step S103), the reading control unit 121a selects one of lines of the R cache memory 111, reads out data corresponding to the line size that includes data stored at the designated address from the main memory 5, and stores the data in the selected line. Then, the reading control unit 121a sets the valid flag (V) of the line, which stores the data therein, to ON and returns the data stored at the designated address to the processor core 11 in Step S105.

In the above-described example, in Step S105, although a line of the cache memory 110, in which data newly read out from the main memory 5 is stored, is secured in the R cache memory 111, the line may be secured in any one of the R cache memory 111 and the W cache memory 112. In such a case, in order to secure and reuse a line, of which the dirty flag (D) is set to ON, of the W cache memory 112, it is necessary to write back data stored in the line (dirty line) into the main memory 5 and reuse the line.

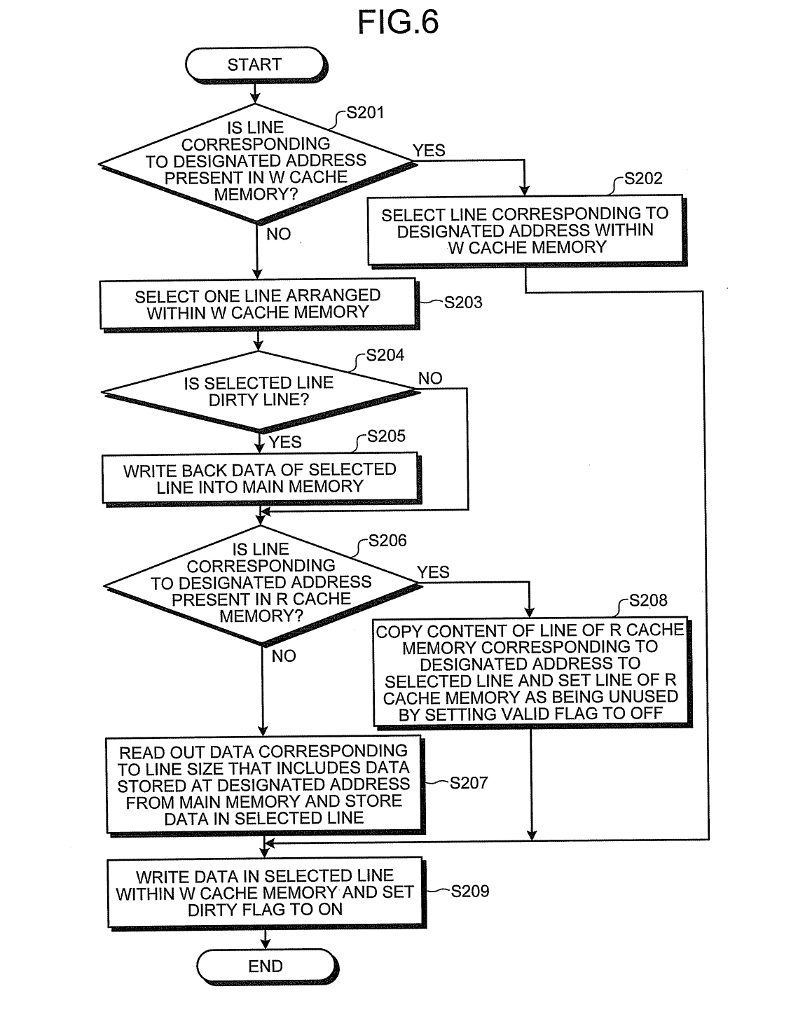

FIG. 6 is a flowchart illustrating the process performed by the writing control unit 122a of the cache controller 120a when the processor core 11 issues a data write request to write data into the main memory 5.

When there is a data write request from the processor core 11 to write data into the main memory 5, the writing control unit 122a, first, determines whether or not a line corresponding to the designated address is present within the W cache memory 112 in Step S201. Then, in a case where the line corresponding to the designated address is present within the W cache memory 112 (Yes in Step S201), the writing control unit 122a selects the corresponding line as a writing target line in Step S202.

On the other hand, in a case where the line corresponding to the designated address is not present within the W cache memory 112 (No in Step S201), the writing control unit 122a selects one line arranged within the W cache memory 112 as a writing target line in Step S203. At this time, in a case where there is a line, of which the dirty flag (D) is set to OFF, within the W cache memory 112, the writing control unit 122a selects the line as a writing target line with high priority, and, in a case where the dirty flags (D) are set to ON in all the lines arranged within the W cache memory 112, in other words, in a case where all the lines arranged within the W cache memory 112 are dirty lines, the writing control unit 122a selects any one of the dirty lines as a writing target line.

Next, the writing control unit 122a determines whether or not the line selected in Step S203 is a dirty line in Step S204. Then, in a case where the line selected in Step S203 is a dirty line (Yes in Step S204), the writing control unit 122a writes back data of the line selected in Step S203 into the main memory 5 in Step S205. On the other hand, in a case where the line selected in Step S203 is not a dirty line (No in Step S204), the process proceeds to the next without performing the process of Step S205.

Next, the writing control unit 122a determines whether or not a line corresponding to the designated address is present within the R cache memory 111 in Step S206. Then, in a case where the line corresponding to the designated address is not present within the R cache memory 111 (No in Step S206), the writing control unit 122a reads out data corresponding to the line size that includes data stored at the designated address from the main memory 5 and stores the data in the line selected in Step S203, in Step S207.

On the other hand, in a case where the line corresponding to the designated address is present within the R cache memory 111 (Yes in Step S206), the writing control unit 122a copies the content of the line, which corresponds to the designated address, of the R cache memory 111 to the line selected in Step S203. Then, the writing control unit 122a sets the valid flag (V) of the line of the R cache memory 111 as a copy source to OFF so as to set the line as being unused in Step S208.

Next, the writing control unit 122a writes data to the designated address of the line selected in Step S202 or Step S203 and sets the dirty flag (D) of the line to ON in Step S209.

The above-described cache memory device 100a according to the first example can be realized based on the cache memory devices of various types that are generally known such as the full associative type, the direct mapping type, and the set associative type. The cache memory device 100a based on the full associative type can be realized by managing the lines of the cache memory 110a divided into two parts by using the cache controller 120a. In the case of the cache memory device 100a based on the direct mapping type, it can be realized by preparing two direct mapping-type cache memories including the R cache memory 111 and the W cache memory 112. In the case of the cache memory device 100a based on the set associative type, it can be realized by the R cache memory 111 and the W cache memory 112 divided in units of sets. For example, in the case of a four-way set associative type, it can be realized such that the number of dirty lines does not exceed 25% of the total number of lines of the cache memory 110a by configuring three ways to be in correspondence with the R cache memory 111 and one way to be in correspondence with the W cache memory 112.

In addition, a write buffer can be added to the above-described cache memory device 100a according to the first example. In the case where the write buffer is added, instead of writing back the data of the lines into the main memory 5 in Step S205 illustrated in FIG. 6, information that is necessary for writing back is stored in the write buffer. The write buffer writes data into the main memory 5 at the opportune time when there is no access from the processor 10 to the main memory 5.

### Second Example

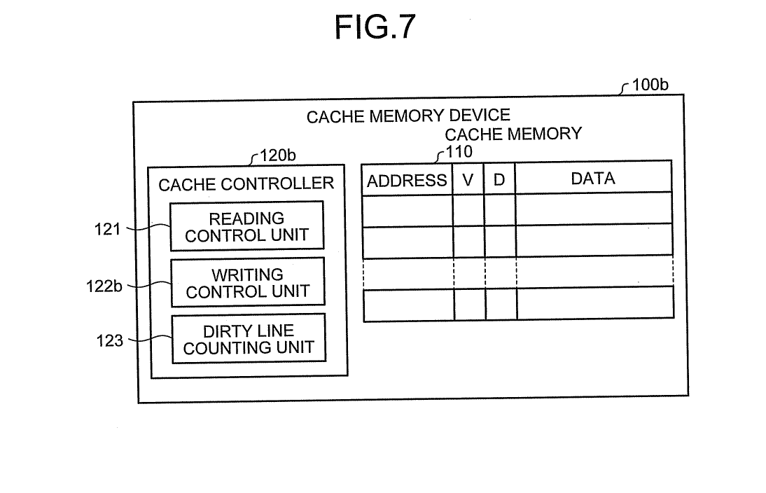

Next, the cache memory device 100b according to the second example will be described. FIG. 7 is a diagram illustrating the configuration of the cache memory device 100b according to the second example. The cache memory device 100b according to the second example includes the cache memory 110 and a cache controller 120b. The cache memory 110 is the same as the cache memory 110 illustrated in FIG. 3.

The cache controller 120b includes the reading control unit 121, a writing control unit 122b, and a dirty line counting unit 123. The reading control unit 121 is the same as the reading control unit 121 illustrated in FIG. 3.

When the processor core 11 issues a data write request to write data into the main memory 5, the writing control unit 122b selects a line of the cache memory 110 that corresponds to the designated address and writes data to a designated address of the line. Then, in a case where the number of dirty lines within the cache memory 110 exceeds the allowable number of lines as a result of the writing of data into the selected line, the writing control unit 122b writes back the data of the dirty lines into the main memory 5. In this way, the number of dirty lines that are present within the cache memory 110 can be maintained to the allowable number of lines or less.

The dirty line counting unit 123 counts the number of dirty lines within the cache memory 110. After writing data in accordance with the data write request from the processor core 11, the writing control unit 122b determines whether or not the number of dirty lines within the cache memory 110 exceeds the allowable number of lines by referring to the output of the dirty line counting unit 123.

Similarly to the cache memory device 100a according to the first example, the cache memory device 100b according to the second example can be realized based on the cache memory devices of various types that are generally known such as the full associative type, the direct mapping type, and the set associative type.

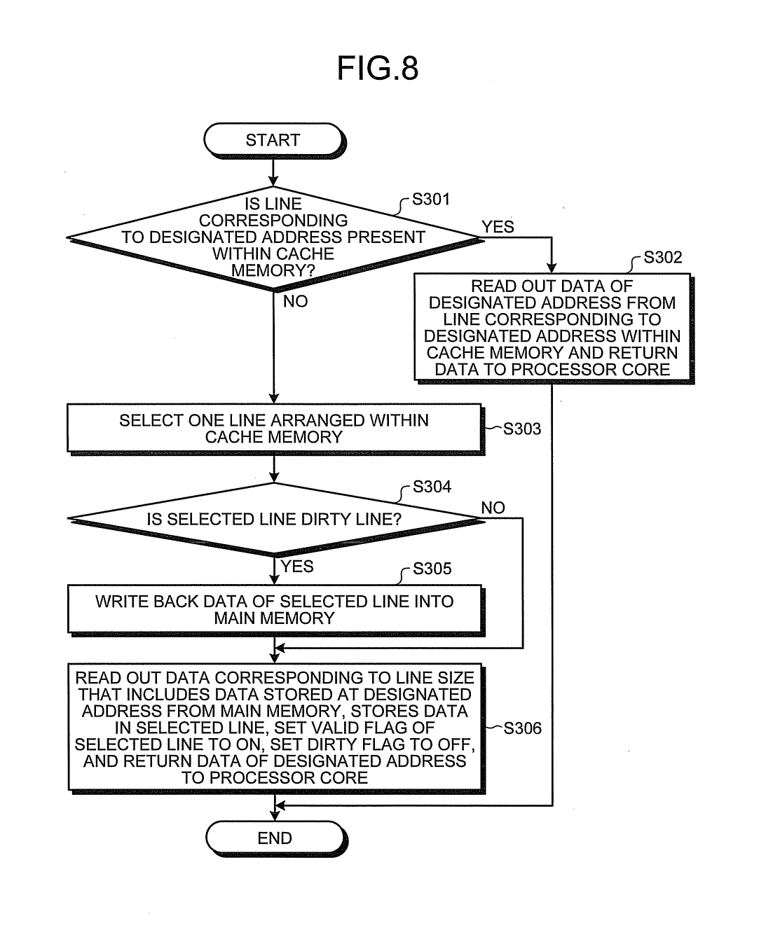

FIG. 8 is a flowchart illustrating the process performed by the reading control unit 121 of the cache controller 120b when the processor core 11 issues a data read request to read data from the main memory 5.

When the processor core 11 issues a data read request to read out data from the main memory 5, the reading control unit 121 determines whether or not a line corresponding to the designated address is present within the cache memory 110 in Step S301. Then, in a case where the line corresponding to the designated address is present within the cache memory 110 (Yes in Step S301), the reading control unit 121 reads out data stored at an address designated from the corresponding line and returns the data to the processor core 11 in Step S302.

On the other hand, in a case where the line corresponding to the designated address is not present within the cache memory 110 (No in Step S301), the reading control unit 121 selects one of lines of the cache memory 110 in Step S303. Then, the reading control unit 121 determines whether or not the line is a dirty line by referring to the dirty flag (D) of the line selected in Step S303, in Step S304. Then, in a case where the line selected in Step S303 is a dirty line (Yes in Step S304), the reading control unit 121 writes back the data of the line selected in Step S303 into the main memory 5 in Step S305. On the other hand, in a case where the line selected in Step S303 is not a dirty line (No in Step S304), the process proceeds to the next without performing the process of Step S305.

Next, the reading control unit 121 reads out data corresponding to the line size that includes data stored at the designated address from the main memory 5 and stores the data into the line selected in Step S303. Then, the reading control unit 121 sets the valid flag (V) of the line storing the data therein to ON, sets the dirty flag (D) to OFF, and returns the data of the designated address to the processor core 11 in Step S306.

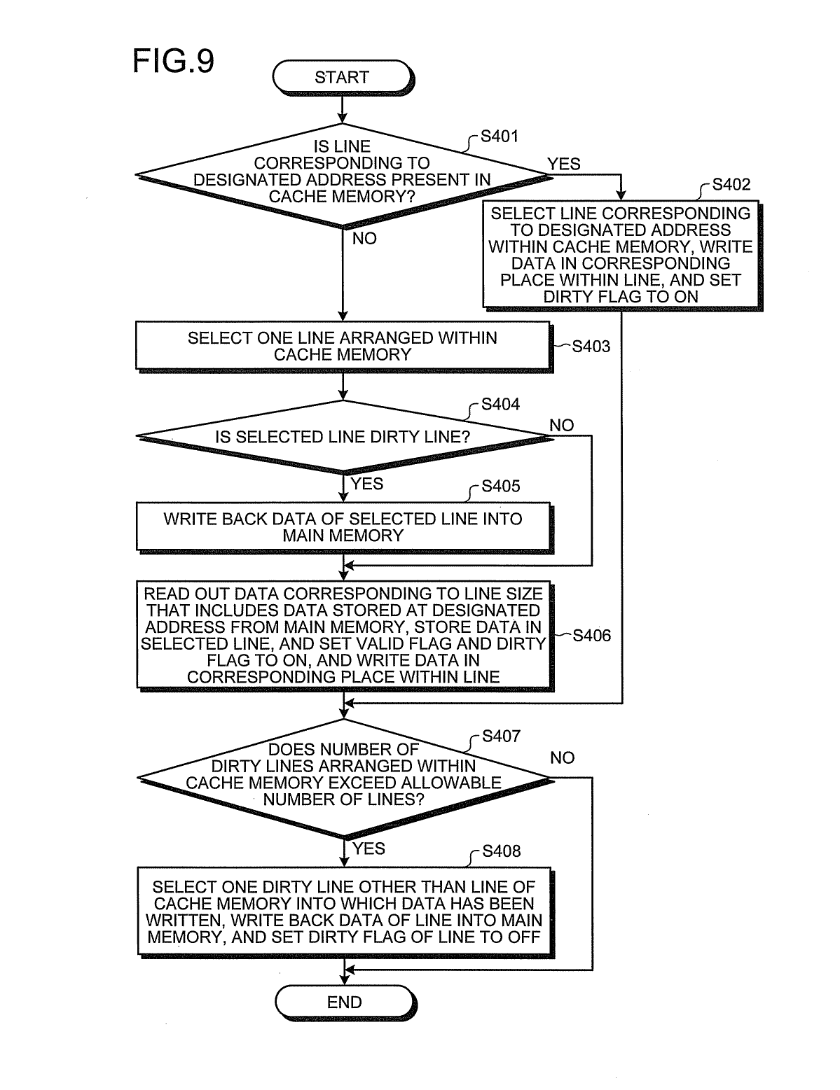

FIG. 9 is a flowchart illustrating the process performed by the writing control unit 122b of the cache controller 120b when the processor core 11 issues a data write request to write data into the main memory 5.

When the processor core 11 issues a data write request to write data into the main memory 5, the writing control unit 122b, first, determines whether or not a line corresponding to the designated address is present within the cache memory 110 in Step S401. Then, in a case where the line corresponding to the designated address is present within the cache memory 110 (Yes in Step S401), the writing control unit 122b selects the corresponding line as a writing target line, writes data into a corresponding place (generally, since the size of the data desired to be written is smaller than the line size, a position within the line into which data is written is calculated from the designated address) within the line, and sets the dirty flag (D) of the line to ON in Step S402.

On the other hand, in a case where the line corresponding to the designated address is not present within the cache memory 110 (No in Step S401), the writing control unit 122b selects one line arranged within the cache memory 110 as a writing target line in Step S403. Next, the writing control unit 122b determines whether or not the line selected in Step S403 is a dirty line in Step S404. Then, in a case where the line selected in Step S403 is a dirty line (Yes in Step S404), the writing control unit 122b writes back data of the line selected in Step S403 into the main memory 5 in Step S405. On the other hand, in a case where the line selected in Step S403 is not a dirty line (No in Step S404), the process proceeds to the next without performing the process of Step S405.

Next, the writing control unit 122b reads out data corresponding to the line size that includes data stored at the designated address from the main memory 5, stores the data in the line selected in Step S403, sets the valid flag (V) and the dirty flag (D) of the line to ON, and writes the data into a corresponding place within the line in Step S406.

Next, the writing control unit 122b determines whether or not the number of dirty lines within the cache memory 110 exceeds the allowable number of lines by referring to the output of the dirty line counting unit 123 in Step S407. Then, in a case where the number of dirty lines within the cache memory 110 reaches the allowable number of lines (Yes in Step S407), the writing control unit 122b selects a line within the cache memory 110 other than the line into which the data has been written in Step S406, writes back the data of the line into the main memory 5, and sets the dirty flag (D) of the line to OFF in Step S408. On the other hand, in a case where the number of dirty lines within the cache memory 110 does not exceed the allowable number of lines (No in Step S407), the process ends without performing the process of Step S408.

In Step S408 illustrated in FIG. 9, the reason for excluding the line into which data has been written in Step S406 when a dirty line of which data is to be written back into the main memory 5 is selected is that the probability of consecutively occurring of a subsequent access to the line into which data has been written is high. However, a line of which data is written back into the main memory 5 may be selected from among all the dirty lines within the cache memory 110 that includes the line into which data has been written in Step S406.

As methods of selecting one line within the cache memory 110 in Step S303 illustrated in FIG. 8 and Step S403 illustrated in FIG. 9, any methods that are generally known can be used. For example, various methods can be used such as a method of selecting a line for which a longest time has elapsed after writing data therein, a method of selecting a line for which a longest time elapses after the last writing, a method of selecting a line for which a longest time has elapsed after the last access (reading or writing), a method of preferentially selecting a line of which the dirty flag (D) is set to OFF, a method of preferentially selecting a line of which the valid flag (V) is set to OFF, a method of randomly selecting a line, and a method combining the above-described methods.

In addition, in the case of the cache memory device 100b based on the full associative type, the range for selecting a line is the whole cache memory 110. In the case of the cache memory device 100b based on the direct mapping type, a line is uniquely determined based on the address of the main memory 5 desired to be accessed, and accordingly, there is one line to be selected. In the case of the cache memory device 100b based on the set associative type, one line for each way is determined based on the address of the main memory 5 desired to be accessed similarly to the direct mapping type, and accordingly, a set of such lines is the target range for selecting a line.

In addition, as a method of selecting a dirty line in Step S408 illustrated in FIG. 9, various methods can be used such as a method of selecting a line for which a longest time elapses after the last writing, a method of selecting a line for which a longest time has elapsed after the last access (reading or writing), a method of randomly selecting a line, and a method combining the above-described methods.

### Third Example

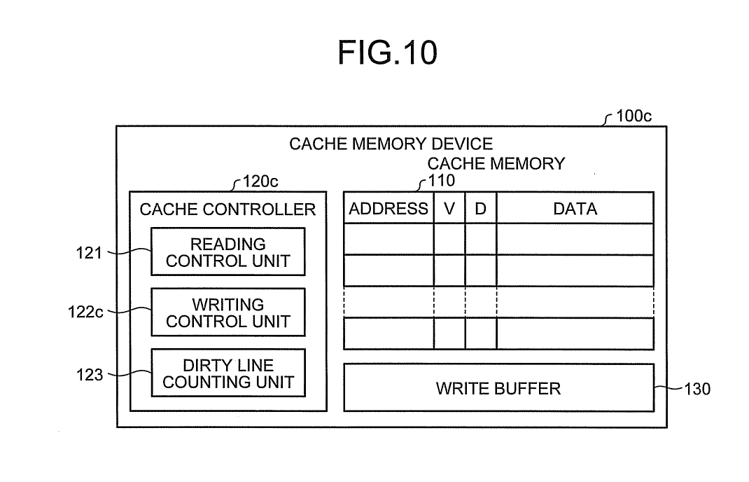

Next, the cache memory device 100c according to the third example will be described. FIG. 10 is a diagram illustrating the configuration of the cache memory device 100c according to the third example. The cache memory device 100c according to the third example includes the cache memory 110, a cache controller 120c, and a write buffer 130. The cache memory 110 is the same as the cache memory 110 illustrated in FIG. 3.

The cache controller 120c includes the reading control unit 121, a writing control unit 122c, and the dirty line counting unit 123. The reading control unit 121 is the same as the reading control unit 121 illustrated in FIG. 3. The dirty line counting unit 123 is the same as the dirty line counting unit 123 illustrated in FIG. 7.

When the processor core 11 issues a data write request from the processor core 11 to write data into the main memory 5, similarly to the writing control unit 122b illustrated in FIG. 7, the writing control unit 122c selects a line of the cache memory 110 that corresponds to the designated address. At this time, in a case where the line corresponding to the designated address is not present within the cache memory 110, the writing control unit 122c selects one line from the cache memory 110 and stores, in the write buffer 130, information that is necessary for writing back the data of the line into the main memory 5 in a case where the selected line is a dirty line. In addition, after writing the data to the designated address of the selected line, the writing control unit 122c determines whether or not the number of dirty lines within the cache memory 110 exceeds the allowable number of lines by referring to the output of the dirty line counting unit 123. Then, in a case where the number of dirty lines within the cache memory 110 exceeds the allowable number of lines, the writing control unit 122c stores, in the write buffer 130, information that is necessary for writing back the data of the dirty lines into the main memory 5.

The write buffer 130 temporarily holds data to be written back into the main memory 5. The write buffer 130 is a mechanism that is generally widely used so as to improve the performance of the cache memory device. In a cache memory device that does not include the write buffer 130, at a time when a dirty line arranged within the cache memory 110 is reused so as to store data stored at a new address or the like, while the data stored at the new address cannot be written when the process of writing back the data of the dirty lines into the main memory 5 is not completed. In contrast, in a cache memory device that includes the write buffer 130, the data stored at the new address can be immediately written when information that is necessary for writing back data into the main memory 5, that is, information configured by an address for the writing back of the data on the main memory 5 and the data is inserted into the write buffer 130. As above, since the cache memory device that includes the write buffer 130 does not need to wait for the completion of the writing back of the data into the main memory 5, there is no stall of the processor 10. In addition, when the set of the address and the data is inserted into the write buffer 130, the writing back of the data into the main memory 5 is performed at appropriate timing. It is preferable to perform the writing back of data when there is no other access to the main memory 5.

The cache memory device 100c of the third example is different form the cache memory device 100b of the second example only in the following point: the information necessary for the writing back of data is stored in the write buffer 130 instead of directly writing back the data of the dirty lines into the main memory 5 by using the writing control unit 122c. Accordingly, in the cache memory device 100c of the third example, similarly to the cache memory device 100b of the second example, the number of dirty lines that are present within the cache memory 110 can be maintained to the allowable number of lines or less. In addition, the cache memory device 100c according to the third example can effectively prevent the stall of the processor 10 that is accompanied with the writing back of the data into the main memory 5.

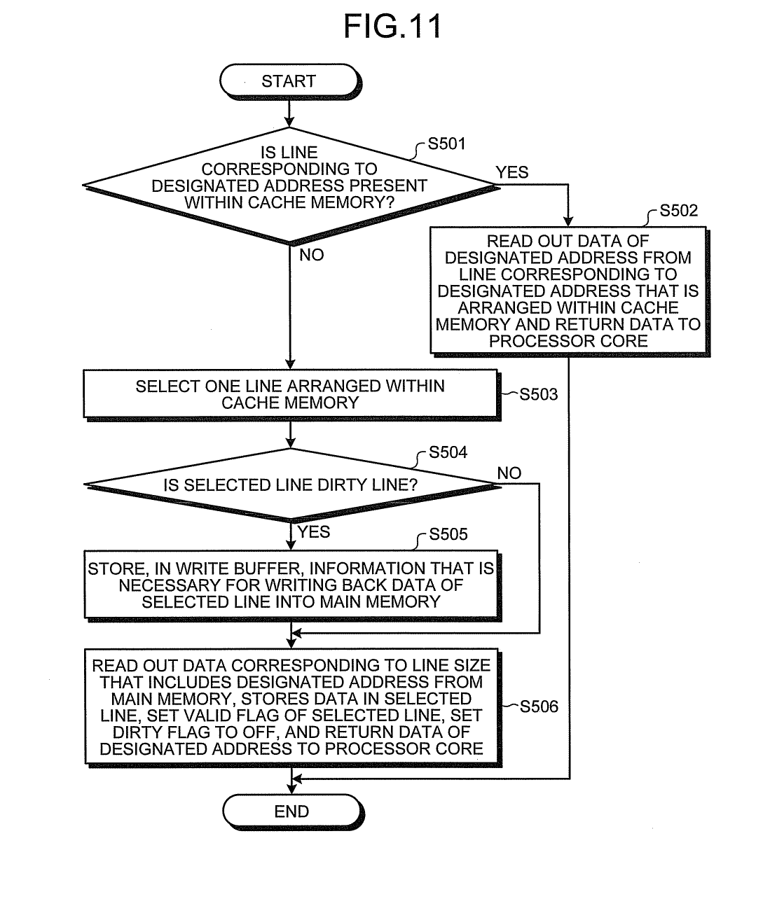

FIG. 11 is a flowchart of the process performed by the reading control unit 121 of the cache controller 120c when the processor core 11 issues a data read request to read data from the main memory 5. The process of Step S501 to Step S504 in the flowchart illustrated in FIG. 11 is the same as the process of Step S301 to Step S304 in the flowchart illustrated in FIG. 8. In addition, the process of Step S506 in the flowchart illustrated in FIG. 11 is the same as the process of Step S306 in the flowchart illustrated in FIG. 8. In the flowchart illustrated in FIG. 11, the process of Step S505 is different from the process illustrated in the flowchart illustrated in FIG. 8.

Specifically, in a case where a line selected in Step S503 is a dirty line (Yes in Step S504), the reading control unit 121 of the cache controller 120c stores, in the write buffer 130, information that is necessary for writing back data of the line selected in Step S503 into the main memory 5 in Step S505.

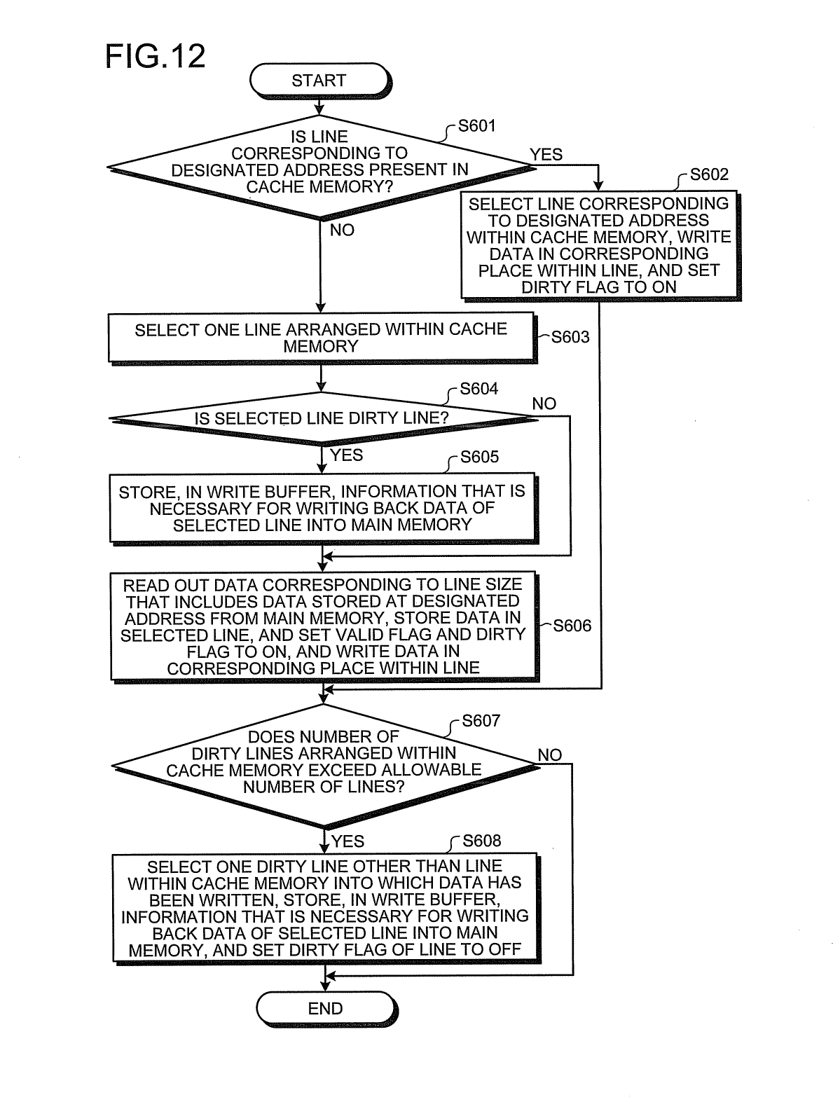

FIG. 12 is a flowchart illustrating the process performed by the writing control unit 122c of the cache controller 120c when the processor core 11 issues a data write request to write data into the main memory 5. The process of Step S601 to Step S604 in the flowchart illustrated in FIG. 12 is the same as the process of Step S401 to Step S404 in the flowchart illustrated in FIG. 9. In addition, the process of Step S606 and Step S607 in the flowchart illustrated in FIG. 12 is the same as the process of Step S406 and Step S407 in the flowchart illustrated in FIG. 9. In the flowchart illustrated in FIG. 12, the process of Step S605 and the process of Step S608 are different from the process illustrated in the flowchart illustrated in FIG. 9.

Specifically, in a case where a line selected in Step S603 is a dirty line (Yes in Step S604), the writing control unit 122c of the cache controller 120c stores, in the write buffer 130, information that is necessary for writing back data of the line selected in Step S603 into the main memory 5 in Step S605.

In addition, in a case where the number of dirty lines within the cache memory 110 reaches the allowable number of lines (Yes in Step S607) after the writing of data in Step S606, in Step S608, the writing control unit 122c of the cache controller 120c selects a dirty line within the cache memory 110 other than the line into which the data has been written in Step S606, stores in the write buffer, the information that is necessary for writing back the data of the line into the main memory 5, and sets the dirty flag (D) of the line to OFF.

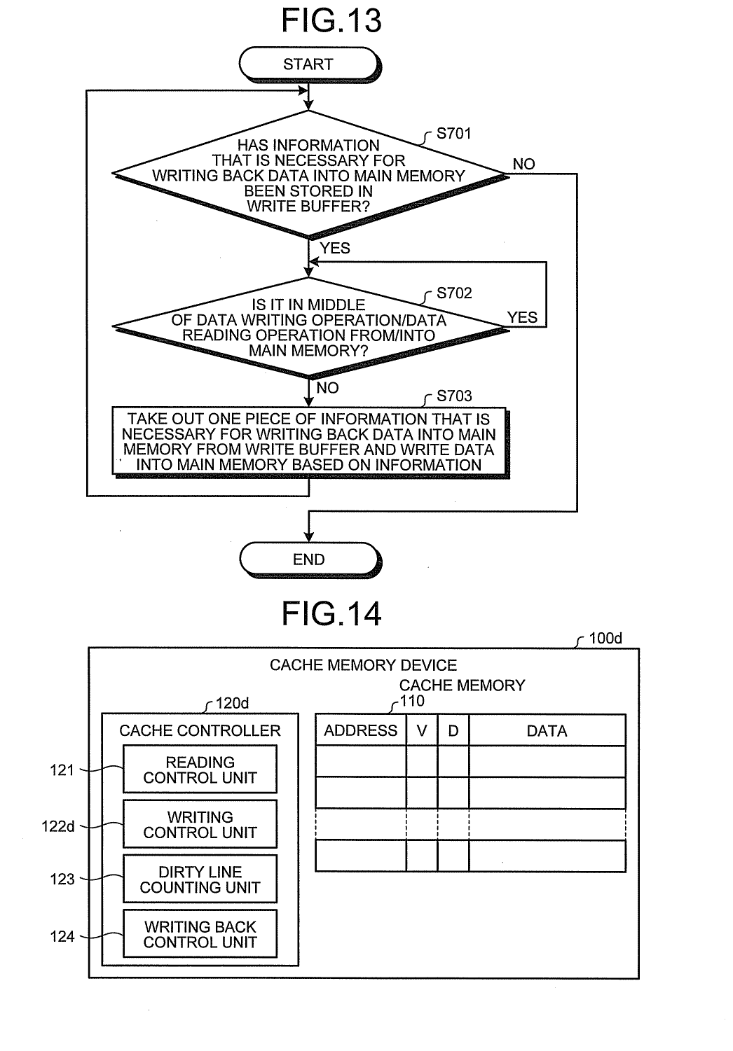

The write buffer 130 performs an operation that is similar to that of a write buffer that is generally used. FIG. 13 is a flowchart illustrating an example of the operation of the write buffer 130. The process illustrated in the flowchart illustrated in FIG. 13 is performed at arbitrary timing such as timing when the processor 10 does not access the main memory 5.

The write buffer 130, first, determines whether or not information that is necessary for writing back data into the main memory 5 is stored therein in Step S701. Then, in a case where the information necessary for writing back data into the main memory 5 is not stored in the write buffer 130 (No in Step S701), the process ends. On the other hand, in a case where the information necessary for writing back data into the main memory 5 is stored (Yes in Step S701), the write buffer 130 determines whether or not the processor 10 is in the state of accessing the main memory 5, in other words, whether or not it is in the middle of a data reading operation from the main memory 5 or a data writing operation into the main memory 5 in Step S702.

Then, in a case where it is in the middle of a data reading operation from the main memory 5 or a data writing operation into the main memory 5 (Yes in Step S702), the write buffer 130 waits until the operation is completed. On the other hand, in a case where neither the data reading operation from the main memory 5 nor the data writing operation into the main memory 5 is not performed (No in Step S702), the write butter 130 takes out one piece of information necessary for writing back the data into the main memory 5 and writes the data into the main memory 5 based on the information that has been taken out in Step S703. Thereafter, the process is returned to Step S701, and the subsequent process is repeated until the writing back of data into the main memory 5 is completed.

### Fourth Example

Next, the cache memory device 100d according to the fourth example will be described. FIG. 14 is a diagram illustrating the configuration of the cache memory device 100d according to the fourth example. The cache memory device 100d according to the fourth example includes the cache memory 110 and a cache controller 120d. The cache memory 110 is the same as the cache memory 110 illustrated in FIG. 3.

The cache controller 120d includes the reading control unit 121, a writing control unit 122d, the dirty line counting unit 123, and a writing back control unit 124. The reading control unit 121 is the same as the reading control unit 121 illustrated in FIG. 3. The dirty line counting unit 123 is the same as the dirty line counting unit 123 illustrated in FIG. 7.

When the processor core 11 issues a data write request to write data to write data into the main memory 5, the writing control unit 122d selects a line of the cache memory 110 that corresponds to the designated address and writes the data to a designated address of the line.

The writing back control unit 124 determines whether or not the number of dirty lines arranged within the cache memory 110 exceeds the allowable number of lines at arbitrarily timing such as timing when the processor 10 does not access the main memory 5 by referring to the output of the dirty line counting unit 123. Then, in a case where the number of dirty lines arranged within the cache memory 110 exceeds the allowable number of lines, the writing back control unit 124 writes back the data of dirty lines into the main memory 5. In this way, even in a case where the number of dirty lines that are present within the cache memory 110 temporarily exceeds the allowable number of lines, the number of dirty lines can be returned to the allowable number of lines or less. In addition, since the process of writing back the data of dirty lines into the main memory 5 is performed at arbitrary timing, the stall of the processor 10 accompanied with the writing back of data into the main memory 5 can be effectively prevented.

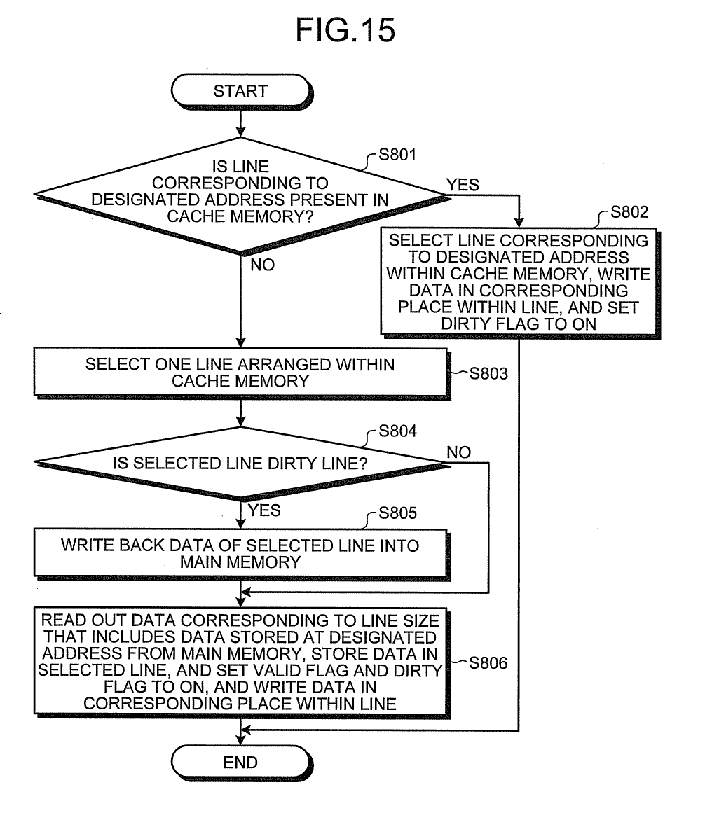

FIG. 15 is a flowchart illustrating the process performed by the writing control unit 122d of the cache controller 120d when the processor core 11 issues a data write request to write data into the main memory 5. The process of Step S801 to Step S806 in the flowchart illustrated in FIG. 15 is the same as the process of Step S401 to Step S406 in the flowchart illustrated in FIG. 9. The flowchart illustrated in FIG. 15 is different from the flowchart illustrated in FIG. 9 in that the process corresponding to Step S407 and Step S408 is not included.

Specifically, when data is written to the designated address of the selected line in Step S802 or Step S806, the writing control unit 122d of the cache controller 120d ends the process.

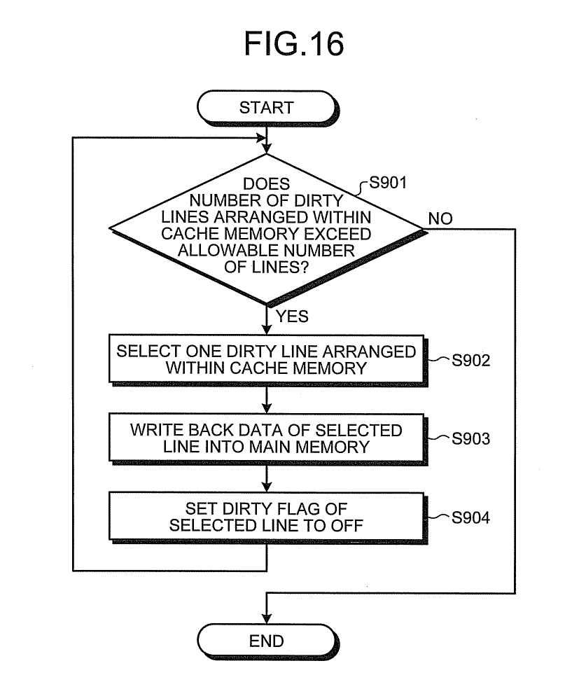

FIG. 16 is a flowchart illustrating an example of the process performed by the writing back control unit 124 of the cache controller 120d. The process illustrated in the flowchart illustrated in FIG. 16 is performed at arbitrary timing such as timing when the processor 10 does not access the main memory 5.

When the process is started, the writing back control unit 124, first, determines whether or not the number of dirty lines arranged within the cache memory 110 exceeds the allowable number of lines by referring to the output of the dirty line counting unit 123 in Step S901. Then, in a case where the number of dirty lines arranged within the cache memory 110 is the allowable number of lines or less (No in Step S901), the writing back control unit 124 ends the process.

On the other hand, in a case where the number of dirty lines arranged within the cache memory 110 exceeds the allowable number of lines (Yes in Step S901), the writing back control unit 124 selects one of the dirty lines arranged within the cache memory 110 in Step S902. Then, the writing back control unit 124 writes back the data of the dirty line selected in Step S902 into the main memory 5 in Step S903 and sets the dirty flag (D) of the line to OFF in Step S904. Thereafter, the process is returned to Step S901, and the subsequent process is repeated until the number of dirty lines arranged within the cache memory 110 is the allowable number of lines and less.

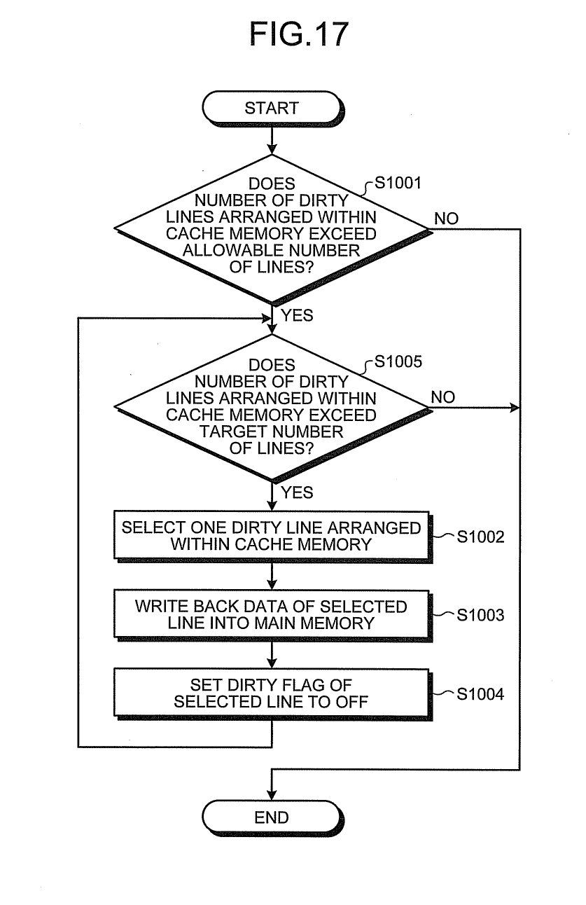

FIG. 17 is a flowchart illustrating another example of the process performed by the writing back control unit 124 of the cache controller 120d. The process of Step S1001 to Step S1004 in the flowchart illustrated in FIG. 17 is the same as the process of Step S901 to Step S904 in the flowchart illustrated in FIG. 16. The flowchart illustrated in FIG. 17 is different from the flowchart illustrated in FIG. 16 that the process of Step S1005 is added.

Specifically, in a case where the number of dirty lines arranged within the cache memory 110 is determined to be the allowable number of lines or less in Step S1001 (No in Step S1001), the writing back control unit 124 determines whether or not the number of dirty lines arranged within the cache memory 110 exceeds the target number of lines in Step S1005. Here, the target number of lines is a target value at the time of decreasing the number of dirty lines arranged within the cache memory 110 and is a number that is smaller than the allowable number of lines.

As a result of the determination made in Step S1005, in a case where the number of dirty lines arranged within the cache memory 110 exceeds the target number of lines (Yes in Step S1005), the process proceeds to Step S1002, and the subsequent process is repeated. Then, when the number of dirty lines arranged within the cache memory 110 becomes the target number of lines or less (No in Step S1005), the process ends.

In a case where the writing back control unit 124 performs the process illustrated in FIG. 17, since the number of dirty lines arranged within the cache memory 110 decreases up to the target number of lines, thereafter, the time until the number of dirty lines arranged within the cache memory 110 reaches the allowable number of lines can be lengthened, whereby the frequency of the writing back of data into the main memory 5 can decrease.

### Fifth Example

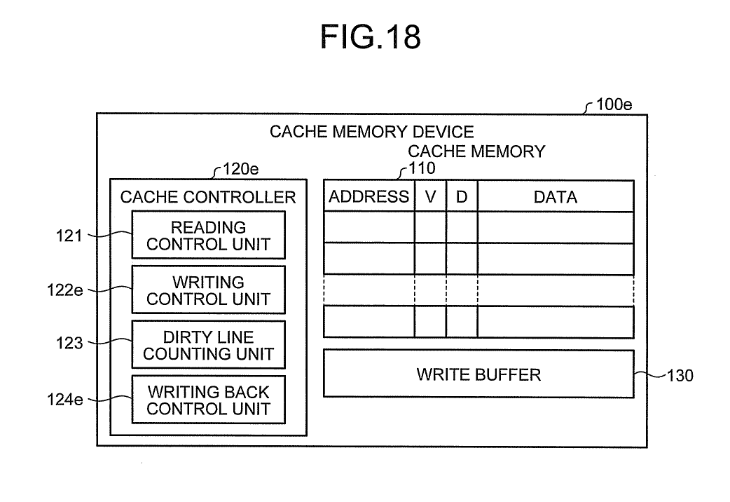

Next, the cache memory device 100e according to the fifth example will be described. FIG. 18 is a diagram illustrating the configuration of the cache memory device 100e according to the fifth example. The cache memory device 100e according to the fifth example includes the cache memory 110, a cache controller 120e, and the write buffer 130. The cache memory 110 is the same as the cache memory 110 illustrated in FIG. 3. The write buffer 130 is the same as the write buffer 130 illustrated in FIG. 10.

The cache controller 120e includes the reading control unit 121, a writing control unit 122e, the dirty line counting unit 123, and a writing back control unit 124e. The reading control unit 121 is the same as the reading control unit 121 illustrated in FIG. 3. The dirty line counting unit 123 is the same as the dirty line counting unit 123 illustrated in FIG. 7.

When the processor core 11 issues a data write request to write data into the main memory 5, similarly to the writing control unit 122d illustrated in FIG. 14, the writing control unit 122e selects a line of the cache memory 110 that corresponds to the designated address. At this time, in a case where the line corresponding to the designated address is not present within the cache memory 110, the writing control unit 122e selects one line arranged in the cache memory 110 and stores, in the write buffer 130, information that is necessary for writing back the data of the line into the main memory 5 in a case where the selected line is a dirty line.

The writing back control unit 124e determines whether or not the number of dirty lines arranged within the cache memory 110 exceeds the allowable number of lines at arbitrarily timing such as timing when the processor 10 does not access the main memory 5 by referring to the output of the dirty line counting unit 123. Then, in a case where the number of dirty lines arranged within the cache memory 110 exceeds the allowable number of lines, the writing back control unit 124e stores, in the write buffer 130, the information that is necessary for the writing back of the data of the dirty lines into the main memory 5. In this way, even in a case where the number of dirty lines that are present within the cache memory 110 temporarily exceeds the allowable number of lines, the number of dirty lines can be returned to the allowable number of lines or less. In addition, instead of directly writing back the data of the dirty lines into the main memory 5, the information that is necessary for the writing back of the data is stored in the write buffer 130, and accordingly, the stall of the processor 10 accompanied with the writing back of data into the main memory 5 can be effectively prevented.

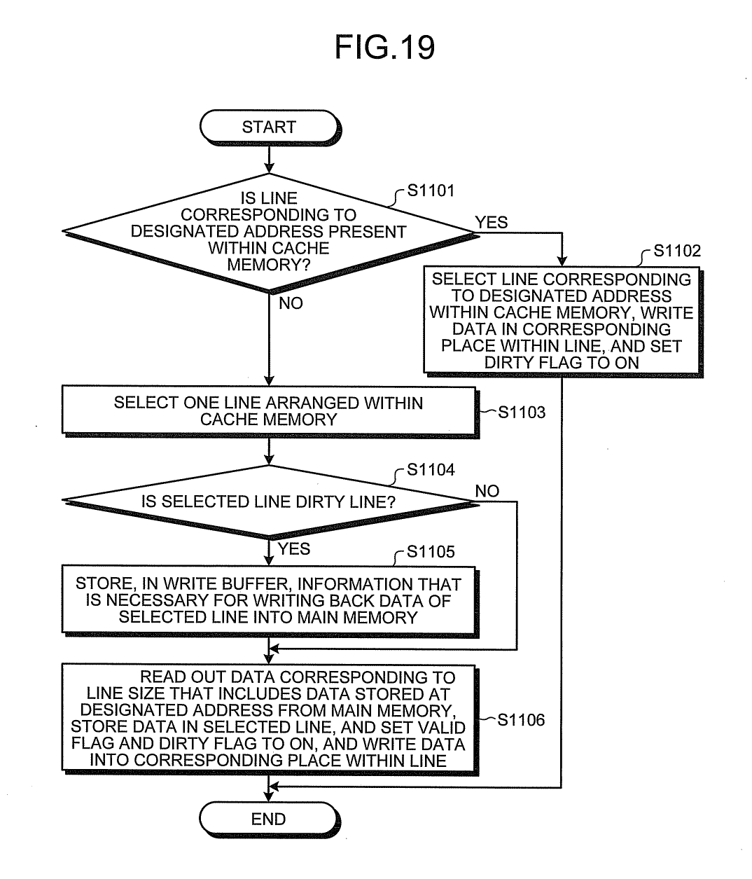

FIG. 19 is a flowchart illustrating the process performed by the writing control unit 122e of the cache controller 120e when the processor core 11 issues a data write request to write data into the main memory 5. The process of Step S1101 to Step S1104 in the flowchart illustrated in FIG. 19 is the same as the process of Step S801 to Step S804 in the flowchart illustrated in FIG. 15. In addition, the process of Step S1106 in the flowchart illustrated in FIG. 19 is the same as the process of Step S806 in the flowchart illustrated in FIG. 15. In the flowchart illustrated in FIG. 19, the process of Step S1105 is different from the process illustrated in the flowchart illustrated in FIG. 15.

In other words, in a case where a line selected in Step S1103 is a dirty line (Yes in Step S1104), the writing control unit 122e of the cache controller 120e stores, in the write buffer 130, information that is necessary for writing back data of the line selected in Step S1103 into the main memory 5 in Step S1105.

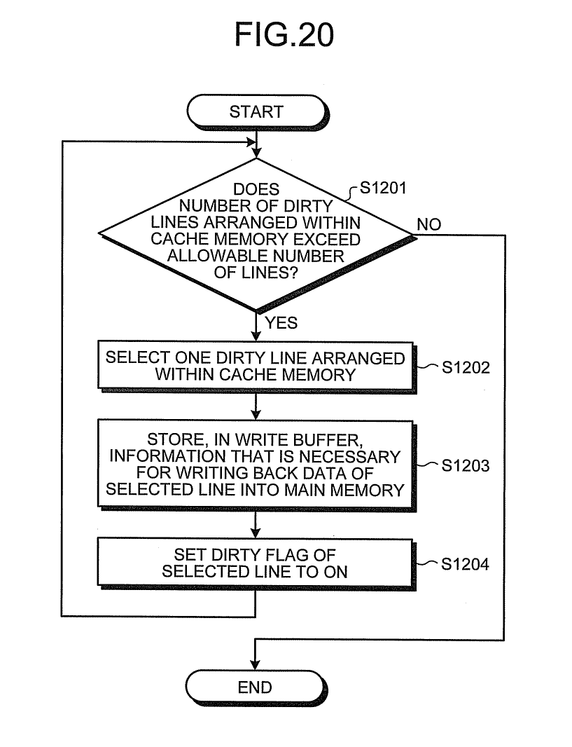

FIG. 20 is a flowchart illustrating an example of the process performed by the writing back control unit 124e of the cache controller 120e. The process of Step S1201 and Step S1202 in the flowchart illustrated in FIG. 20 is the same as the process of Step S901 and Step S902 in the flowchart illustrated in FIG. 16. In addition, the process of Step S1204 in the flowchart illustrated in FIG. 20 is the same as the process of Step S904 in the flowchart illustrated in FIG. 16. In the flowchart illustrated in FIG. 20, the process of Step S1203 is different from the process illustrated in the flowchart illustrated in FIG. 16.

Specifically, the writing back control unit 124e of the cache controller 120e stores, in the write buffer 130, the information that is necessary for the writing back of the data of the dirty line selected in Step S1202 into the main memory 5 in Step S1203.

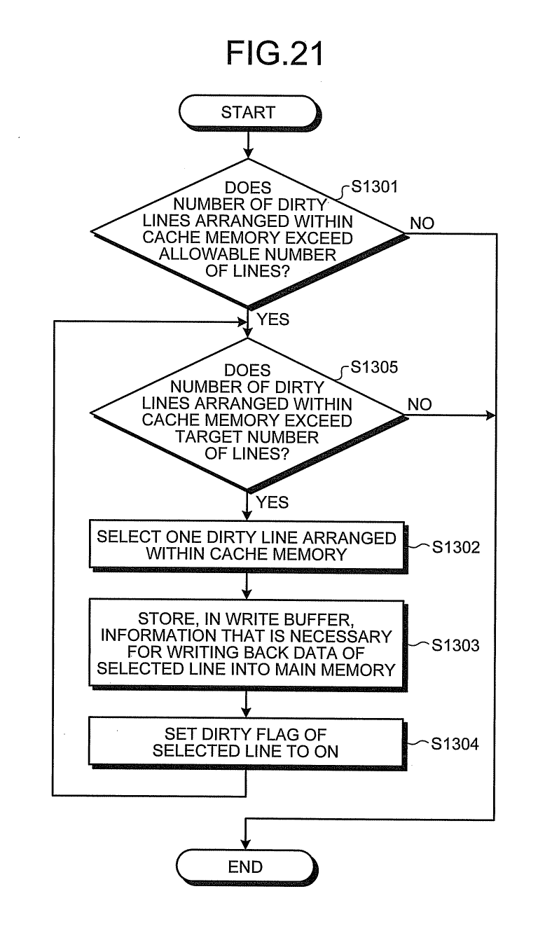

FIG. 21 is a flowchart illustrating another example of the process performed by the writing back control unit 124e of the cache controller 120e. The process of Step S1301 and Step S1302 in the flowchart illustrated in FIG. 21 is the same as the process of Step S1001 and Step S1002 in the flowchart illustrated in FIG. 17. In addition, the process of Step S1304 and Step S1305 in the flowchart illustrated in FIG. 21 is the same as the process of Step S1004 and Step S1005 in the flowchart illustrated in FIG. 17. In the flowchart illustrated in FIG. 21, the process of Step S1303 is different from the process illustrated in the flowchart illustrated in FIG. 17.

Specifically, the writing back control unit 124e of the cache controller 120e stores, in the write buffer 130, the information that is necessary for the writing back of the data of the dirty line selected in Step S1302 into the main memory 5 in Step S1303.

### Sixth Example

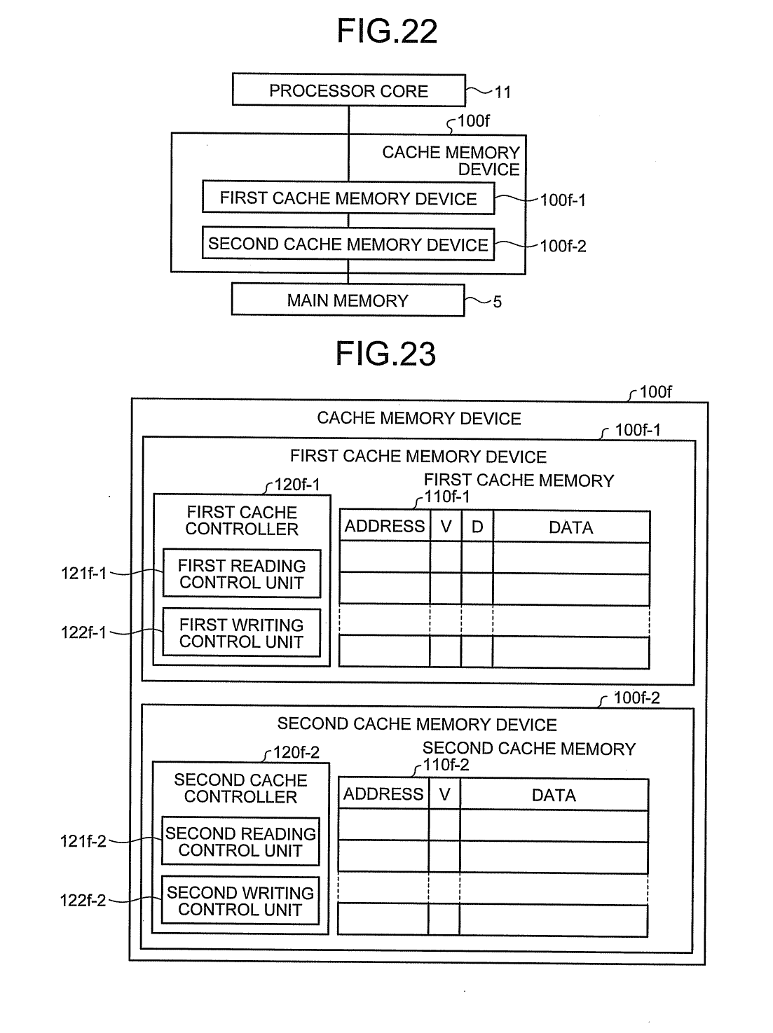

Next, the cache memory device 100f according to the sixth example will be described. FIG. 22 is a diagram illustrating an outline of the cache memory device 100f according to the sixth example. The cache memory device according to the sixth example has a configuration in which a first cache memory device 100f-1 and a second cache memory device 100f-2 are hierarchically combined. The first cache memory device 100f-1 arranged on the processor core 11 side operates as a cache memory device of the write-back type having lines, the number of which is the same as the allowable number of lines. The second cache memory device 100f-2 arranged between the first cache memory device 100f-1 and the main memory 5 operates as a cache memory device of the write-through type having lines, the number of which is arbitrary. Since the second cache memory device 100f-2 is of the write-through type, a dirty line is not present therein. According to such a combination, the maximum number (allowable number of lines) of dirty lines arranged within the cache memory device 100f that is configured by the first cache memory device 100f-1 and the second cache memory device 100f-2 can be suppressed to the number of lines that is the same as the maximum number of dirty lines arranged within the first cache memory device 100f-1.

FIG. 23 is a diagram illustrating the configuration of the cache memory device 100f according to the sixth example. The cache memory device 100f according to the sixth example includes the first cache memory device 100f-1 and the second cache memory device 100f-2. The first cache memory device 100f-1 includes first cache memory (first memory area) 110f-1 and a first cache controller (first controller) 120f-1. The first cache controller 120f-1 includes a first reading control unit 121f-1 and a first writing control unit 122f-1. The second cache memory device 100f-2 includes second cache memory (second memory area) 110f-2 and a second cache controller (second controller) 120f-2. The second cache controller 120f-2 includes a second reading control unit 121f-2 and a second writing control unit 122f-2.

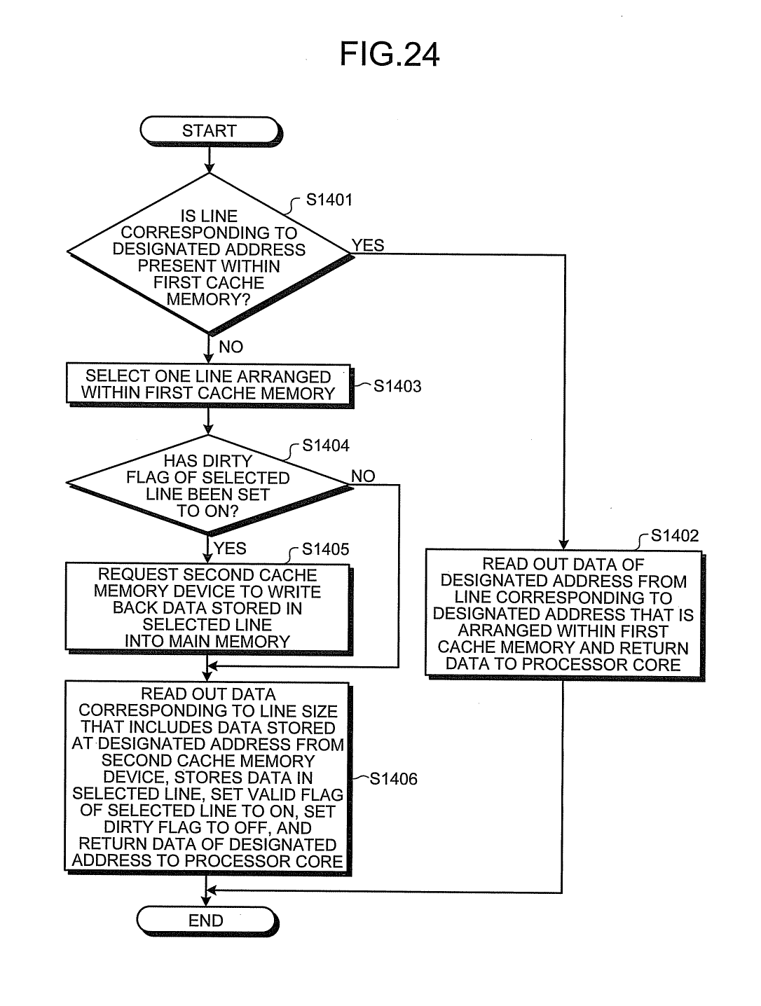

FIG. 24 is a flowchart illustrating the process performed by the first reading control unit 121f-1 of the first cache controller 120f-1 when the processor core 11 issues a data read request to read data from the main memory 5.

When the processor core 11 issues a data read request to read out data from the main memory 5, the first reading control unit 121f-1, first, determines whether or not a line corresponding to the designated address is present within the first cache memory 110f-1 in Step S1401. Then, in a case where the line corresponding to the designated address is present within the first cache memory 110f-1 (Yes in Step S1401), the first reading control unit 121f-1 reads out data stored at an address designated from the corresponding line and returns the data to the processor core 11 in Step S1402.

On the other hand, in a case where the line corresponding to the designated address is not present within the first cache memory 110f-1 (No in Step S1401), the first reading control unit 121f-1 selects one of lines of the first cache memory 110f-1 in Step S1403. Then, the first reading control unit 121f-1 determines whether or not the line is a dirty line by referring to the dirty flag (D) of the line selected in Step S1403, in Step S1404. Then, in a case where the line selected in Step S1403 is a dirty line (Yes in Step S1404), the first reading control unit 121f-1 requests the second cache memory device 100f-2 to write back the data stored in the line selected in Step S1403 into the main memory 5, in Step S1405. On the other hand, in a case where the line selected in Step S1403 is not a dirty line (No in Step S1404), the process proceeds to the next without performing the process of Step S1405.

Next, the first reading control unit 121f-1 reads out data corresponding to the line size that includes data stored at the designated address from the second cache memory device 100f-2 and stores the data in the line selected in Step S1403. Then, the first reading control unit 121f-1 sets the valid flag (V) of the line storing the data therein to ON, sets the dirty flag (D) to OFF, and returns the data of the designated address to the processor core 11 in Step S1406.

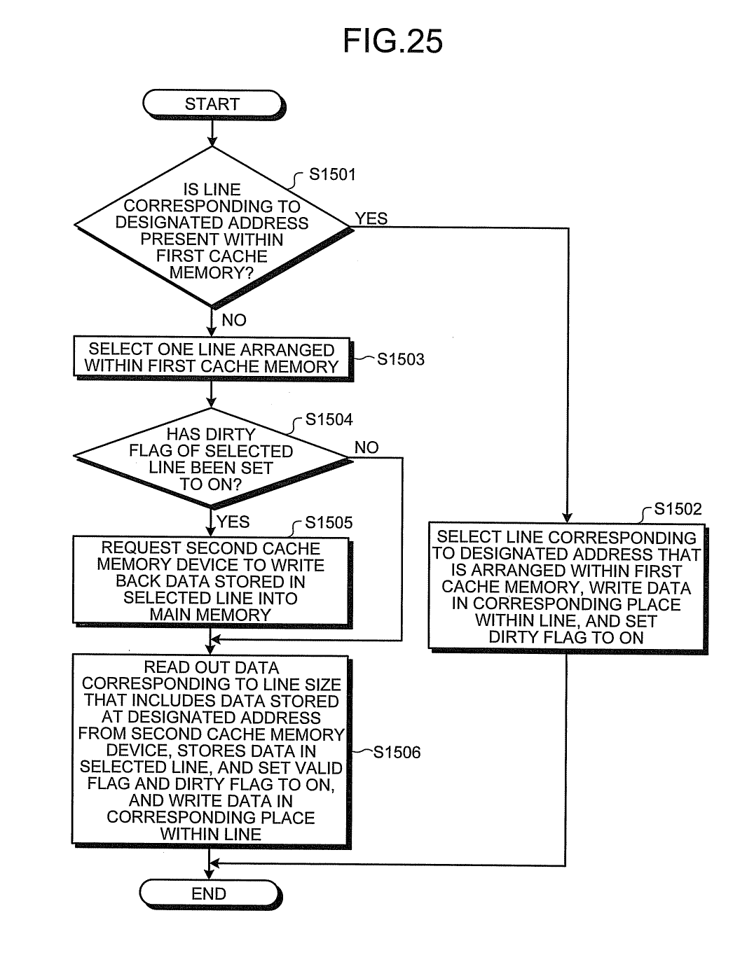

FIG. 25 is a flowchart illustrating an example of the process performed by the first writing control unit 122f-1 of the first cache controller 120f-1 when the processor core 11 issues a data write request to write data into the main memory 5.

When the processor core 11 issues a data write request to write data into the main memory 5, the first writing control unit 122f-1, first, determines whether or not a line corresponding to the designated address is present within the first cache memory 110f-1 in Step S1501. Then, in a case where the line corresponding to the designated address is present within the first cache memory 110f-1 (Yes in Step S1501), the first writing control unit 122f-1 selects the corresponding line as a writing target line, writes data into a corresponding place within the line, and sets the dirty flag (D) of the line to ON in Step S1502.

On the other hand, in a case where the line corresponding to the designated address is not present within the first cache memory 110f-1 (No in Step S1501), the first writing control unit 122f-1 selects one line arranged within the first cache memory 110f-1 as a writing target line in Step S1503. Next, the first writing control unit 122f-1 determines whether or not the line selected in Step S1503 is a dirty line by referring to the dirty flag (D) of the line, which is selected in Step S1503, in Step S1504. Then, in a case where the line selected in Step S1503 is a dirty line (Yes in Step S1504), the first writing control unit 122f-1 requests the second cache memory device 100f-2 to write back data stored in the line, which is selected in Step S1503, into the main memory 5 in Step S1505. On the other hand, in a case where the line selected in Step S1503 is not a dirty line (No in Step S1504), the process proceeds to the next without performing the process of Step S1505.

Next, the first writing control unit 122f-1 reads out data corresponding to the line size that includes data stored at the designated address from the second cache memory device 100f-2, stores the data in the line selected in Step S1503, sets the valid flag (V) of the line to ON, and writes the data into a corresponding place within the line in Step S1506.

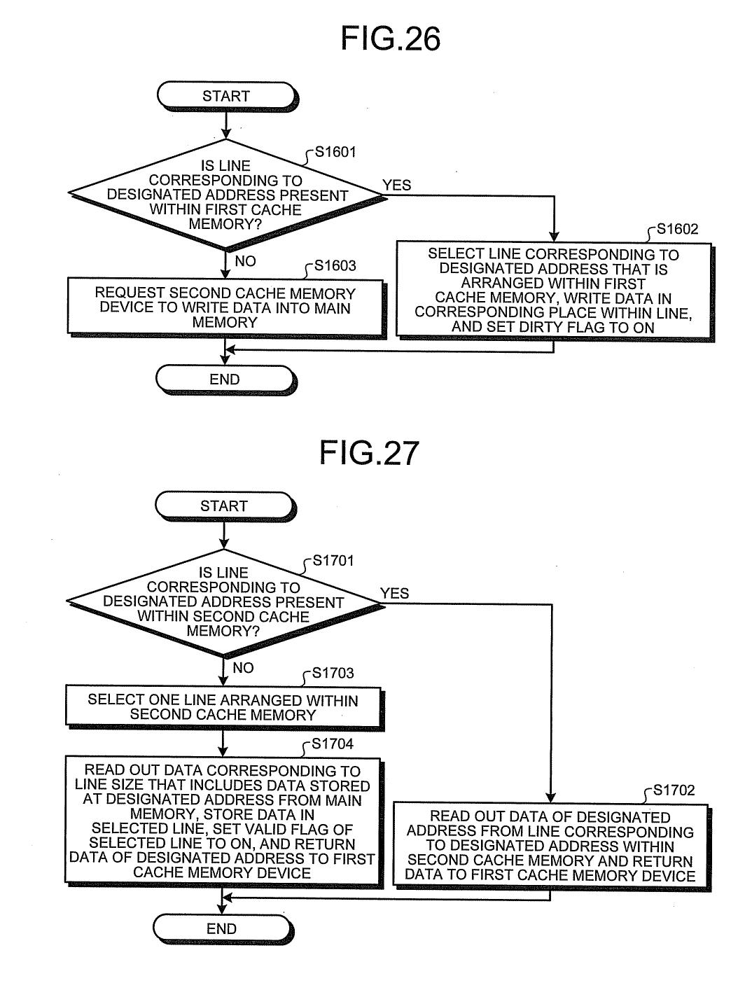

FIG. 26 is a flowchart illustrating another example of the process performed by the first writing control unit 122f-1 of the first cache controller 120f-1 when the processor core 11 issues a data write request to write data into the main memory 5. The example illustrated in FIG. 25 and the example illustrated in FIG. 26 are different from each other in the processing method employed in a case where the line corresponding to the data stored at an address as a writing target is not present within the first cache memory 110f-1, in other words, at the time of a miss-hit when a data write request from the processor core 11 to write data into the main memory 5 is processed by the first writing control unit 122f-1. In the example illustrated in FIG. 25, a method is employed in which, when a miss-hit occurs in a write operation, the miss-hit state is resolved by reading out data corresponding to the line size that includes data stored at the corresponding address from the main memory 5 and writing the data into a newly secured line. On the other hand, in the example illustrated in FIG. 26, when a miss-hit occurs in a write operation, the second cache memory device 100f-2 is requested to write the data into the main memory 5.

When the processor core 11 issues a data write request to write data into the main memory 5, the first writing control unit 122f-1, first, determines whether or not a line corresponding to the designated address is present within the first cache memory 110f-1 in Step S1601. Then, in a case where the line corresponding to the designated address is present within the first cache memory 110f-1 (Yes in Step S1601), the first writing control unit 122f-1 selects the corresponding line as a writing target line, writes data into a corresponding place within the line, and sets the dirty flag (D) of the line to ON in Step S1602.

On the other hand, in a case where the line corresponding to the designated address is not present within the first cache memory 110f-1 (No in Step S1601), the first writing control unit 122f-1 requests the second cache memory device 100f-2 to write the data into the main memory 5 in Step S1603.

FIG. 27 is a flowchart illustrating the process performed by the second reading control unit 121f-2 of the second cache controller 120f-2 when the first cache memory device 100f-1 issues a data read request to read data from the main memory 5.

When the first cache memory device 100f-1 (described in detail, the first cache controller 120f-1 arranged within the first cache memory device 100f-1) issues a data read request to read data from the main memory 5, the second reading control unit 121f-2, first, determines whether or not a line corresponding to the designated address is present within the second cache memory 110f-2 in Step S1701. Then, in a case where the line corresponding to the designated address is present within the second cache memory 110f-2 (Yes in Step S1701), the second reading control unit 121f-2 reads out data stored at an address designated from the corresponding line and returns the data to the first cache memory device 100f-1 in Step S1702.

On the other hand, in a case where the line corresponding to the designated address is not present within the second cache memory 110f-2 (No in Step S1701), the second reading control unit 121f-2 selects one line of the second cache memory 110f-2 in Step S1703. Next, the second reading control unit 121f-2 reads out data corresponding to the line size that includes data stored at the designated address from the main memory 5 and stores the data in the line selected in Step S1703. Then, the second reading control unit 121f-2 sets the valid flag (V) of the line storing the data therein to ON and returns the data stored at the designated address to the first cache memory device 100f-1 in Step S1704.

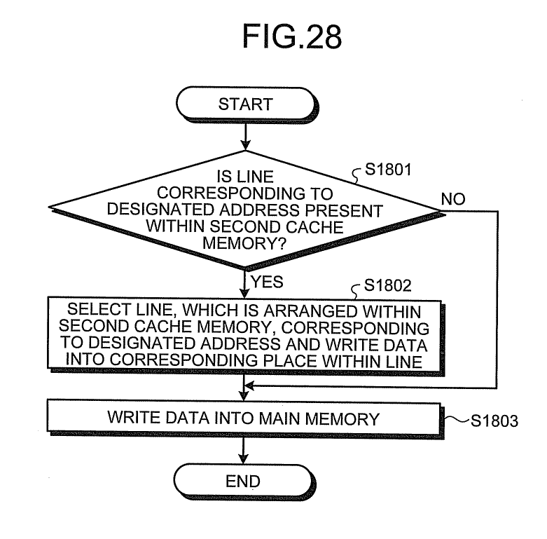

FIG. 28 is a flowchart illustrating the process performed by the second writing control unit 122f-2 of the second cache controller 120f-2 when the first cache memory device 100f-1 issues a data write request to write data into the main memory 5.

When the first cache memory device 100f-1 (described in detail, the first cache controller 120f-1 arranged within the first cache memory device 100f-1) issues a data write request to write data into the main memory 5, the second writing control unit 122f-2, first, determines whether or not a line corresponding to the designated address is present within the second cache memory 110f-2 in Step S1801. Then, in a case where the line corresponding to the designated address is present within the second cache memory 110f-2 (Yes in Step S1801), the second writing control unit 122f-2 selects the corresponding line as a writing target line and writes the data at a corresponding place within the line in Step S1802. On the other hand, in a case where the line corresponding to the designated line is not present within the second cache memory 110f-2 (No in Step S1801), the process proceeds to the next without performing the process of Step S1802.

Next, the second writing control unit 122f-2 writes the data into the main memory 5 in Step S1803.

The first cache memory device 100f-1 may be configured to include a write buffer 130. In addition, the second cache memory device 100f-2 may be configured to include a write buffer 130.

As illustrated in FIG. 22, the relation between the first cache memory device 100f-1 and the second cache memory device 100f-2 included in the cache memory device 100f according to the sixth example is the same as the relation between a level-1 cache arranged close to a processor core 11 and a level-2 cache arranged close to the main memory 5 in an SoC (System on a Chip) or a processor that includes two hierarchical layers of cache memory devices. Accordingly, by using an SoC or a processor that includes a hierarchical cache memory device configured by the level-1 cache and the level-2 cache and can set the control types of the level-1 cache and the level-2 cache to the write back type or the write through type, an operation based on this example can be performed by setting the number of lines of the level-1 cache as the allowable number of lines, setting the level-1 cache to the write back type, and setting the level-2 cache to the write through type.

Variation in Processor

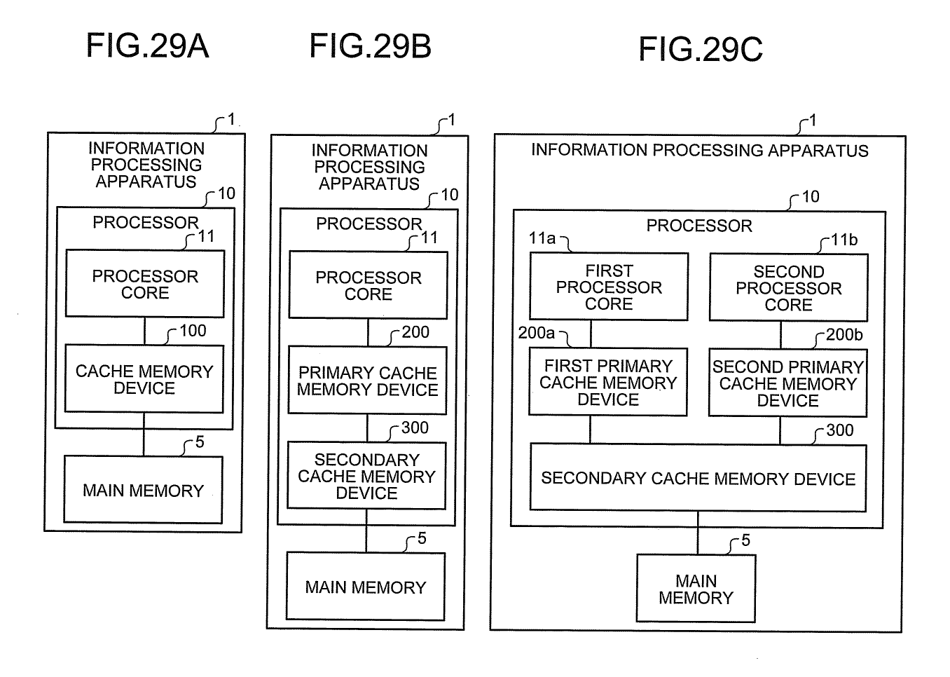

The cache memory device 100 according to the embodiment, which has been described in detail with the examples 1 to 6, can be applied to the processor 10 having any one of various configurations. FIGS. 29A to 29C are diagrams illustrating the variations in the processor 10 included in the information processing apparatus 1. The configuration of the processor 10 illustrated in FIG. 2 coincides with the example illustrated in FIG. 29A.

An example illustrated in FIG. 29B is an example in which the processor 10 includes a primary cache memory device 200 and a secondary cache memory device 300. In a case where the processor 10 has the configuration illustrated in FIG. 29B, the primary cache memory device 200 is the cache memory device 100 according to the embodiment. In addition, the target of the cache memory device 100 according to the embodiment for writing back data is the secondary cache memory device 300. Furthermore, in a case where the sixth example is performed as a modified example as illustrated in FIG. 29B, the primary cache memory device 200 is a hierarchical cache memory device that is configured by the level-1 cache and the level-2 cache.

Although it is preferable to realize the secondary cache memory device 300 as a non-volatile cache memory device using a non-volatile memory technique such as MRAM or PCM, the secondary cache memory device 300 may be configured by using SRAM. In addition, the secondary cache memory device 300 may be either the write through type or the write back type. By configuring the secondary cache memory device 300 as the write back type, the frequency of accessing the main memory 5 can be decreased. In addition, in the example illustrated in FIG. 29B, although a configuration is employed in which the cache memory devices of two stages including the primary cache memory device 200 and the secondary cache memory device 300 are included, a configuration may be employed in which cache memory devices of three stages or more are included. Even in the case of the configuration including the cache memory devices of three stages or more, the primary cache memory device 200 is the cache memory device 100 of the embodiment.

An example illustrated in FIG. 29C is an example in which the processor 10 is configured as a multi-core processor that includes a first processor core 11a and a second processor core 11b. In the example illustrated in FIG. 29C, the first processor core 11a uses a first primary cache memory device 200a, and the second processor core 11b uses a second primary cache memory device 200b. In addition, the secondary cache memory device 300 that is common to the first primary cache memory device 200a and the second primary cache memory device 200b is arranged.

In a case where the processor 10 has the configuration illustrated in FIG. 29C, the first primary cache memory device 200a and the second primary cache memory device 200b form the cache memory device 100 according to the embodiment. The target of the cache memory device 100 according to the embodiment for writing back data is the secondary cache memory device 300. In addition, in the example illustrated in FIG. 29C, although a configuration is employed in which two processor cores including the first processor core 11a and the second processor core 11b are included, a configuration may be employed in which three or more processor cores are included. Even in the case of the configuration in which three or more processor cores are included, the primary cache memory device used by each processor core is the cache memory device 100 according to the embodiment.

As described above, the cache memory device 100 according to the embodiment basically employs the writing method of the write back type, limits the number of dirty lines that are present within the cache memory 110 to the allowable number of lines, and, in a case where the number of dirty lines exceeds the number of allowable number of lines, writes back the data of the dirty lines into the main memory 5. Accordingly, by utilizing the advantage of the write back type in which the frequency of writing data into the main memory 5 during the execution of a program by using the processor 10 can be decreased, the amount of data that is written back from the cache memory 110 into the main memory 5 at the time of blocking the supply of power can be suppressed. Therefore, according to the processor 10 including the cache memory device 100 of the embodiment, the time and the power consumption required for switching from the execution mode to the deep standby mode in which the supply of power to the cache memory device 100 is blocked can be reduced, and accordingly, the switching to the deep standby mode can be performed even for a very short standby time, whereby significant reduction in the power consumption can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cache memory device that caches data stored in or data to be stored in a memory device, the cache memory device comprising:
a memory area that includes a plurality of cache lines; and
a controller configured to, when the number of dirty lines among the cache lines exceeds a predetermined number, write data of the dirty lines into the memory device, each of the dirty lines containing data that is not written in the memory device.

2. The device according to claim 1, wherein
the memory area includes a first memory area that includes an arbitrary number of the cache lines and a second memory area that includes the predetermined number of the cache lines, and
the controller performs data writing only on the cache lines of the second memory area, and when the dirty lines of the second memory area is reused, writes the data of the dirty lines into the memory device.

3. The device according to claim 1, wherein, when the number of the dirty lines exceeds the predetermined number as a result of writing data into any of the cache lines, the controller writes the data of the dirty lines into the memory device.

4. The device according to claim 1, wherein the controller counts the number of the dirty lines at arbitrary timing and, when the number of the counted dirty lines exceeds the predetermined number, writes the data of the dirty lines into the memory device.

5. The device according to claim 1, wherein
the memory area includes a first memory area that includes the predetermined number of the cache lines and a second memory area that includes an arbitrary number of the cache lines,
the controller includes a first controller that controls the first memory area and a second controller that controls the second memory area,
the first controller performs data writing only on the cache lines of the first memory area and, when the dirty lines of the first memory area is reused, instructs the second controller to write the data of the dirty lines into the memory device, and
the second controller writes the data of the dirty lines into the memory device in accordance with the instruction from the first controller.

6. The device according to claim 1, wherein the memory device is a non-volatile secondary cache memory device.

7. The device according to claim 1, further comprising:
a write buffer configured to temporarily hold the data of the dirty lines, wherein
the controller outputs the data of the dirty lines to the write buffer and writes the data of the dirty lines from the write buffer into the memory device at arbitrary timing.

8. A processor comprising:
a processor core configured to execute a program through accessing a memory device; and
a cache memory device configured to cache data stored in or data to be stored in the memory device, wherein
the cache memory device includes:
a memory area that includes a plurality of cache lines; and
a controller configured to, when the number of dirty lines among the cache lines exceeds a predetermined number, write data of the dirty lines into the memory device, each of the dirty lines containing data that is not written in the memory device.

9. The processor according to claim 8, wherein
the memory area includes a first memory area that includes an arbitrary number of the cache lines and a second memory area that includes the predetermined number of the cache lines, and
the controller performs data writing only on the cache lines of the second memory area, and when the dirty lines of the second memory area is reused, writes the data of the dirty lines into the memory device.

10. The processor according to claim 8, wherein, when the number of the dirty lines exceeds the predetermined number as a result of writing data into any of the cache lines, the controller writes the data of the dirty lines into the memory device.

11. The processor according to claim 8, wherein the controller counts the number of the dirty lines at arbitrary timing and, when the number of the counted dirty lines exceeds the predetermined number, writes the data of the dirty lines into the memory device.

12. The processor according to claim 8, wherein
the memory area includes a first memory area that includes the predetermined number of the cache lines and a second memory area that includes an arbitrary number of the cache lines,
the controller includes a first controller that controls the first memory area and a second controller that controls the second memory area,
the first controller performs data writing only on the cache lines of the first memory area and, when the dirty lines of the first memory area is reused, instructs the second controller to write the data of the dirty lines into the memory device, and
the second controller writes the data of the dirty lines into the memory device in accordance with the instruction from the first controller.

13. The processor according to claim 8, wherein the memory device is a non-volatile secondary cache memory device.

14. An information processing apparatus comprising:
a memory device;
a processor core configured to execute a program through accessing the memory device; and
a cache memory device configured to cache data stored in or data to be stored in the memory device, wherein
the cache memory device includes:
a memory area that includes a plurality of cache lines; and
a controller configured to, when the number of dirty lines among the cache lines exceeds a predetermined number, write data of the dirty lines into the memory device, each of the dirty lines containing data that is not written in the memory device.

15. The apparatus according to claim 14, wherein
the memory area includes a first memory area that includes an arbitrary number of the cache lines and a second memory area that includes the predetermined number of the cache lines, and
the controller performs data writing only on the cache lines of the second memory area, and when the dirty lines of the second memory area is reused, writes the data of the dirty lines into the memory device.

16. The apparatus according to claim 14, wherein, when the number of the dirty lines exceeds the predetermined number as a result of writing data into any of the cache lines, the controller writes the data of the dirty lines into the memory device.

17. The apparatus according to claim 14, wherein the controller counts the number of the dirty lines at arbitrary timing and, when the number of the counted dirty lines exceeds the predetermined number, writes the data of the dirty lines into the memory device.

18. The apparatus according to claim 14, wherein
the memory area includes a first memory area that includes the predetermined number of the cache lines and a second memory area that includes an arbitrary number of the cache lines,
the controller includes a first controller that controls the first memory area and a second controller that controls the second memory area,
the first controller performs data writing only on the cache lines of the first memory area and, when the dirty lines of the first memory area is reused, instructs the second controller to write the data of the dirty lines into the memory device, and
the second controller writes the data of the dirty lines into the memory device in accordance with the instruction from the first controller.

19. The apparatus according to claim 14, wherein the memory device is a non-volatile secondary cache memory device.
